(19) United States
(12) Patent Application Publication
(10) Pub. No.: US 2025/0131012 A1
(43) Pub. Date: Apr. 24, 2025

(54) MACHINE LEARNING SHARD PLACEMENT FOR STATEFUL SERVICES

(71) Applicant: Meta Platforms, Inc., Menlo Park, CA (US)

(72) Inventors: Huseyin Ozgur Tan, San Jose, CA (US); Chengyi Zhang, Santa Clara, CA (US); Yang Gao, Foster City, CA (US); Yaobin Qin, Santa Clara, CA (US)

(73) Assignee: Meta Platforms, Inc., Menlo Park, CA (US)

(21) Appl. No.: 18/493,397

(22) Filed: Oct. 24, 2023

(51) Int. Cl. G06F 16/27; G06F 11/34

(52) U.S. Cl. CPC G06F 16/27; G06F 11/3409

(57) ABSTRACT

Systems, apparatuses and methods provide technology that receives different numbers of accesses to a data shard from different regions, where the data shard is a portion of a dataset. The technology identifies, with a machine learning model, access patterns based on the different numbers of accesses, and generates, with the machine learning model, values for the different regions based on the access patterns, where the values represent ranks of the different regions that correspond to a future number of predicted accesses to the data shard from the different regions. The technology determines a subset of the different regions to store the data shard based on the values and stores a replica of the data shard in each of the subset of the regions without scarifying latency.

### BACKGROUND

Services may have different expectations of performance and data retrieval. For example, a latency-insensitive service may have no expectation of latency. A latency-sensitive service may have an elevated expectation of latency. Sensitive services may have a percentile based latency expectation (e.g., P90, P75, and P50).

### SUMMARY

A system of one or more computers may be configured to perform particular operations or actions by virtue of having software, firmware, hardware, or a combination of them installed on the system that in operation causes or cause the system to perform the actions. One or more computer programs may be configured to perform particular operations or actions by virtue of including instructions that, when executed by data processing apparatus, cause the apparatus to perform the actions.

One general aspect includes at least one computer readable storage medium that includes a set of instructions, which when executed by a computing device, cause the computing device to receive different numbers of accesses to a data shard from different regions, where the data shard is a portion of a dataset. The instructions, when executed, cause the computing device to identify, with a machine learning model, access patterns based on the different numbers of accesses, and generate, with the machine learning model, values for the different regions based on the different numbers of accesses, where the values indicate whether the different regions are to receive the data shard or be bypassed to receive the data shard. The instructions, when executed, cause the computing device to determine a subset of the different regions to store the data shard based on the values. The instructions, when executed, cause the computing device to store a replica of the data shard in each of the subset of the different regions.

One general aspect includes a system that includes one or more processors. The system also includes a memory coupled to the one or more processors, the memory may include instructions executable by the one or more processors. The one or more processors being operable when executing the instructions to receive different numbers of accesses to a data shard from different regions, where the data shard is a portion of a dataset, identify, with a machine learning model, access patterns based on the different numbers of accesses, and generate, with the machine learning model, values for the different regions based on the different numbers of accesses, where the values indicate whether the different regions are to receive the data shard or be bypassed to receive the data shard, determine a subset of the different regions to store the data shard based on the values, and store a replica of the data shard in each of the subset of the different regions. Other examples of this aspect include corresponding computer systems, apparatus, and computer programs recorded on one or more computer storage devices, each configured to perform the actions of the methods.

One general aspect includes a method comprising receiving different numbers of accesses to a data shard from different regions, where the data shard is a portion of a dataset. The method also includes identifying, with a machine learning model, access patterns based on the different numbers of accesses, and generating, with the machine learning model, values for the different regions based on the different numbers of accesses, where the values indicate whether the different regions are to receive the data shard or be bypassed to receive the data shard. The method also includes determining a subset of the different regions to store the data shard based on the values. The method also includes storing a replica of the data shard in each of the subset of the different regions. Other examples of this aspect include corresponding computer systems, apparatus, and computer programs recorded on one or more computer storage devices, each configured to perform the actions of the methods.

### BRIEF DESCRIPTION OF THE DRAWINGS

The various advantages of the examples will become apparent to one skilled in the art by reading the following specification and appended claims, and by referencing the following drawings, in which:

FIG. 1 illustrates a process to distribute a data shard according to an example of the disclosure;

FIG. 2 illustrates a decorrelated encoding technique according to an example of the disclosure;

FIG. 3 illustrates an exemplary ML framework according to an example of the disclosure;

FIG. 4 illustrates a process to generate an input sample set according to an example of the disclosure;

FIG. 5 illustrates a machine learning inference process according to an example of the disclosure;

FIG. 6 illustrates a training phase for a machine learning, prediction based, smart replication according to an example of the disclosure;

FIG. 7 illustrates an inference process according to an example of the disclosure;

FIG. 8 is a flowchart of an example of a method to train a machine learning model and determine data shard placement according to an example of the disclosure;

FIG. 9 illustrates an example network environment associated with a social-networking system according to an example of the disclosure;

FIG. 10 illustrates an example social graph according to an example of the disclosure; and

FIG. 11 illustrates an example computer system according to an example of the disclosure.

### DESCRIPTION EXAMPLE

As noted, sensitive services may have a percentile based latency expectation (e.g., P90, P75, and P50). Hence, such sensitive services gives the headroom to develop strategies to save storage and memory overhead by reducing unnecessary shard placement on regions.

Some types of datasets (e.g., online marketplace data, social network data with millions of users, database, etc.) are too large to reasonably store together on a single node (e.g., a server). A data shard may be a smaller portion (subset) of a sizeable dataset. The sizeable dataset may be partitioned or divided into smaller, more manageable pieces referred to as shards (data shards). Data sharding may be effectively incorporated into distributed systems to improve scalability and performance by distributing data shards across multiple servers or nodes that may service clients within a geographic range of the services or nods. Each server or node that stores a specific shard of the data is responsible for processing queries or operations related to that specific shard.

Infrastructures may host high-demand services that have high latency demands for end-to-end delivery flow. To satisfy the latency demands, an entire copy of a dataset may be replicated and deployed to all regions supported by the infrastructures. A region may be a geographical area serviced by the infrastructure. For example, the infrastructure may serve a significant amount of users that are divided into geographic regions. The entire geographic area serviced by the infrastructure may be divided into geographic regions that may be independently analyzed for quality-of-service and support. As the number of products supported by the infrastructure increases, system features are upgraded, and more regions are deployed, the services may become memory bound and scalability and growth may be impaired. Thus, while replicating the dataset across all regions may reduce latency, doing so may be impractical, unnecessarily consume computing resources and may be inefficient. That is, to meet the latency demands (e.g., a latency constraint), the data shards may be selectively replicated across the different regions.

Enterprise indexer systems (e.g., an infrastructure) may serve various services that have different latency demands. To satisfy the latency expectations, the whole copy of the data is replicated and deployed to all regions. As the number of products supported by the infrastructure increases, the continuous improvement of the system features, and more regions are deployed, the services may become memory bound and challenge the scalability to support the system growth. Thus, the replication of all data becomes less efficient and less available.

Based on observations on the services by the inventors, the access of the data or shard is not uniformly distributed to all regions. Skipping some regions with a small number of access for the shard placement may not have an impact on the expected percentile based latency (e.g., P90), but also achieve significant memory saving. The fast development of machine learning makes machine learning widely used and achieve significant success in many areas. Examples of an indexer system as described herein may be more intelligent to perform shard placement, have better responsiveness to the dynamic system environment, and enhanced memory saving without sacrificing the latency by introducing machine learning strategies to have an accurate prediction of the access patterns. Thus, examples reduce the memory and storage overhead without significant compromise to latency. If there was no latency constraint (e.g., no expectation of timely and low latency transfers of data), it would be possible to just keep the shard in a single region. Since examples herein relate to latency expectations, examples determine which regions may be skipped for shard placement.

Accesses to the data shards are not uniformly distributed to all regions. Some regions may originate more accesses to the data shards than other regions. Bypassing the other regions (that have a small number of accesses to the data shard) for data placement may not have a significant impact on an expected percentile based latency (e.g., P90), but also achieves significant memory saving. Selectively storing replicas of the data shards may be challenging. For example, if the replicas are stored in regions with low amounts of accesses to the data shard, the replicas may consume computing resources without significant benefits to latency. Alternatively, if the replicas are not stored in high-access regions with high accesses to the data shard, latency and bandwidth consumption may increase since data of the replicas will be transmitted to the high-access regions from other regions that are potentially distant to the high-access regions.

Thus, some examples perform enhanced data shard placement and storage analysis to obtain better responsiveness to a dynamic system environment. Examples reduce memory consumption while still meeting latency constraints. Some examples include machine learning. By introducing machine learning techniques, examples may generate an accurate prediction of the access patterns at a future time. Thus, examples may incorporate artificial intelligence (AI) to facilitate intelligent and smart replication. For example, the AI may be trained to solve an optimization problem, which is minimizing the replication number of the data shards, while meeting a latency constraint. The latency constraint may be a percentile based latency expectation (e.g., P90, P95, P85, etc.). A minimum number of replicas of the data shards may be generated for fault tolerance. Some examples may sort the regions based on the queries-per-second (which may be referred to as the access numbers) from the highest to the lowest, and replicate the data shards in the highest access regions (e.g., regions that collectively have a total access number that meet a target percentile or number of data accesses).

Doing so provides several technical enhancements, such as reducing the compute resources (e.g., memory) to store datasets while still meeting latency constraints. That is, examples may predict future access information for different regions, and store replicas of data shards accordingly. Furthermore, examples may employ a lightweight machine learning model (e.g., classification model) that is trainable with reduced latency, smaller datasets and compute resources relative to other machine learning models (e.g., forecasting models). As such, examples herein provide several technical enhancements.

Thus, examples as described herein enhance existing infrastructure in several ways. Firstly, examples may avoid excessive compute resources being unnecessarily dedicated to data shard storage. Rather, examples herein replicate data shards to geographic regions that are predicted to have the highest number of accesses in a time period, while not storing the data shards in geographic regions with lower predicted accesses to the data shards. Furthermore, examples may operate with low-overhead AI models (e.g., machine learning models, neural networks, etc.).

To accomplish the above, during training examples generate training data including an input part and an output by using historical access data and a de-correlated encoding process. Examples also train a machine learning model by using the generated training data. During inference, examples receive different numbers of accesses to a data shard from different regions, where the data shard is a portion of a dataset, generate values for the different regions based on the different numbers of accesses, where the values indicate whether the different regions are to receive the data shard or be bypassed to receive the data shard, determine a subset of the different regions to store the data shard based on the values and store a replica of the data shard in each of the subset of the regions. Doing so reduces the memory resources consumed by the data shards while also meeting latency expectations.

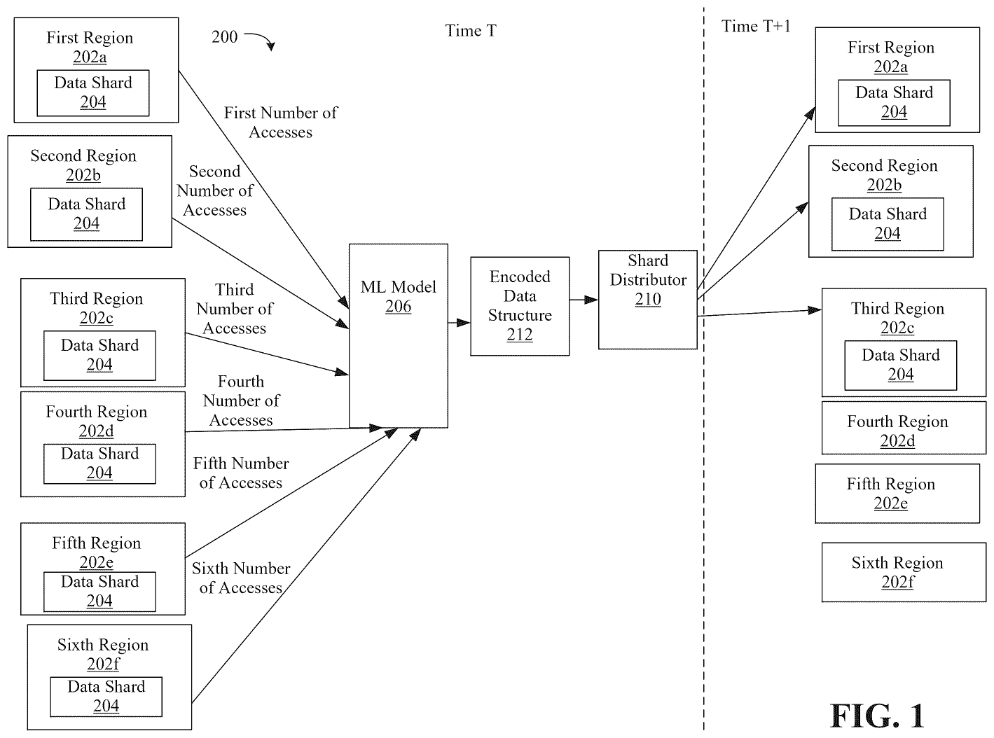

Turning now to FIG. 1, a process 200 to train a machine learning model 206 to place a data shard 204 is described. One or more aspects of process 200 may be implemented in a computing device, computing system (e.g., hardware, configurable logic, fixed-function logic hardware, at least one computer readable storage medium comprising a set of instructions for execution, etc.). In some examples, the process 200 is implemented in a distributed computing system or infrastructure.

Initially, at time t, the data shard 204 is replicated across first-sixth regions 202a-202f. The data shards 204 may be accessed from users within the first-sixth regions. Each of the first-sixth regions 202a-202f (e.g., geographic regions) may store a local replica of the data shard 204 that is accessed by the users of the first-sixth data region 202a-202f. For example, users in the first region 202a may access the data shard 204 of the first region 202a for a first number of accesses. Users in the second region 202b may access the data shard 204 of the second region 202b for a second number of accesses. Users in the third region 202c may access the data shard 204 of the third region 202c for a third number of accesses. Users in the fourth region 202d may access the data shard 204 of the fourth region 202b for a fourth number of accesses. Users in the fifth region 202e may access the data shard 204 of the fifth region 202e for a fifth number of accesses. Users in the sixth region 202b may access the data shard 204 of the sixth region 202b for a sixth number of accesses. The data shards 204 may be replicas of each other (e.g., copies). Further, it is important to note that while first-sixth regions 202a-202f are described, the present examples may be applied to any number of regions.

The ML model 206 may predict where to place the data shard 204. To do so, the ML model 206 may generate metrics (e.g., encoded values) that describe future accesses to the first-sixth regions 202a-202e based on the first-sixth numbers of accesses, and determine which regions of the first-sixth region 202a-202e should store replicas of the data shard 204. For example, to apply an optimal plan for smart replication, examples, such as the ML model 206, may predict the future access pattern of every respective region of the first-sixth region 202a-202e and determine whether the respective region may store the data shard 204 or should by bypassed and should not store the data shard 204. In some examples, ML model 206 may not provide accurate predictions of the future access patterns. Indeed, attempting to do so often times results in incorrect predictions and sub-optimal placements of the data shards 204. Rather, the ML model 206 provides a prediction related to placement of the data shard 204. That is, examples translate a forecasting strategy (e.g., prediction of future accesses) into a classification strategy (e.g., where to store data shards based on encoded values corresponding to future accesses) that is independent of an identification of predicted future accesses.

The benefit of such a translation is as follows. Accurate forecasting is not a trivial approach. Forecasting based machine learning models have larger training overhead (e.g., number of training data, model complexity, and training time, etc.) compared to classification models. That is, forecasting ML models are trained based on a large number of observations to generalize predictions in a time series format.

In the classification based approach, a significant amount of training overhead may be reduced relative to a forecasting approach. For example, a model trained with the classification based approach has a more comprehensive understanding about the causal relationship between inputs and the outputs. Compared to the forecasting approach, the input of the classification provides more direct and effective information. Such input may be referred to as “features” that are used for the prediction.

Forecasting the number of accesses may also cause mis-predictions. For example, a prediction/forecasting error (may be referred to as simply “error”) in an access number of a region will be propagated to the other regions in the shard placement due to the nature of the optimal solution to the smart replication. For example, the over or under prediction of a region's access pattern may have a significant negative impact on the placement decision making. As a detailed example, shard placement may be determined based on relative amounts of predicted accesses. Thus, if the forecaster over-predicts the access number for a region “A” by a significant amount, the region “A” may dominate the analysis and be identified as having a shard placement. Other regions (B, C, D) may be forecasted as having a significantly lower number of predicted accesses relative to region “A,” and may be bypassed for shard placement even if the lower number of predicted accesses is still significant causing increases in latency, bandwidth and inefficiency.

The classification based approach independently classifies every region, and as such the classification based approach may not suffer from error propagation. Thus, the ML model 206 may employ a classification based approach, since the classification based approach may operate more effectively than the forecasting based approach when data related to the causal relationships between the input and output is provided. Examples provide more effective information to the ML model 206, and thus a large training overhead may be reduced compared to the forecasting based approach while the prediction task is significantly simplified.

In this example, the ML model 206 may employ a classification based approach. In some examples, ML model 206 employs smart replication to address shard placement, so the prediction of the details about access numbers to first-sixth regions 202a-202e may not be emphasized. An encoding method is employed to decorrelate the output format and reduce the overhead of training. After training, the ML model 206 may bypass the decorrelated output format, and rather classify each region of the first-sixth regions 202a-202e as either receiving a shard, or not receiving a shard. Thus, during inference values may be generated that indicate whether a region should receive a shard or not receive a shard.

At time T, the ML model 206 generates the encoded data structure 212. The encoded data structure 212 may include rankings and/or indicators of which of the first-sixth regions 202a-202e are going to be most frequently accessed. Notably, the encoded data structure 212 may not include actual data access predictions and/or percent access, but instead may include rankings of the first-sixth regions 202a-202e. For example, the number of accesses and/or the percentages cannot be determined based on the encoded data structure 212. In some examples, the ML model 206 generates the encoded data structure 212 independently of the first-sixth number of data accesses (e.g., is not based on the first-sixth number of accesses), and instead may rely on other inputs (e.g., time of day, content of the data shard, etc.).

The encoded data structure 212 may include a different value for each region of the first-sixth regions 202a-202f. A positive value may indicate that a corresponding region of the first-sixth regions 202a-202f receives the data shard 204, while a negative value may indicate that a corresponding region of the first-sixth regions 202a-202f does not receive the data shard 204.

A shard distributor 210 may receive the encoded values of the encoded data structure 212 and determine the shard placement for the data shard 204. In this example, the data shard 204 is replicated to the first region 202a, the second region 202b and the third region 202c based on the first-third regions 202a-202c having positive values in the encoded data structure 212. The fourth-sixth regions 202d-202e are not selected for shard placement based on the fourth-sixth regions 202d-202e having negative numbers in the encoded data structure 212.

While one data shard 204 is described above, it will be understood that the above process 200 may be applied to more than one data shard. Furthermore, it will also be understood that data shard 204 may refer to replicas of the data shard 204. It may also be understood that the above process 200 may be re-executed at predetermined time intervals (e.g., hourly) to adjust the data shard 204 placements in real-time and to meet current demands. In some examples, the ML model 206 may be retrained at predetermined time intervals to enhance responsiveness. The ML model 206 may be retrained iteratively based on whether the predictions for data shard 204 were identified as being effective (e.g., number of accesses met a threshold).

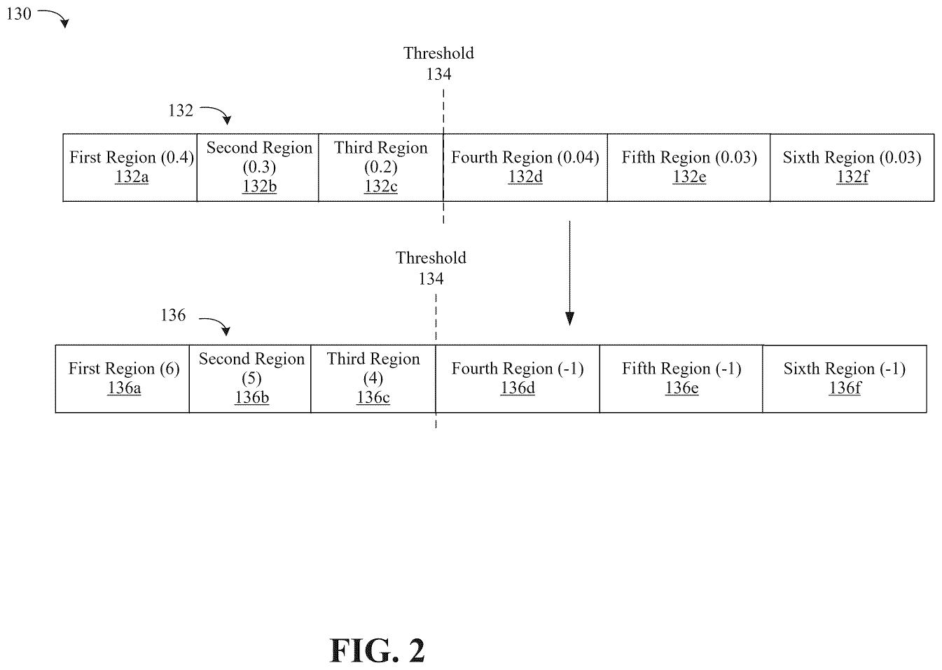

Turning now to FIG. 2, a decorrelated encoding technique 130 is illustrated. The decorrelated encoding technique 130 may be executed during training. The decorrelated encoding technique 130 may train the ML model 206 (FIG. 1), and may not be employed during inference. Rather, during inference ML model 206 may generate encoded data structure 136 without generating percentage ranked structure 132. Thus, the decorrelated encoding technique 130 may be employed prior to process 200 (e.g., inference-based process) being executed to train the ML model 206.

During training, access numbers to each of first-sixth regions are calculated based on historical data as accesses. The percentages are converted into a decimal format and stored in a percentage ranked structure 132. The access numbers (e.g., access data) to a data shard are used for the training process and are recorded historical data. This access data may be referred to as training data. The training data is divided into two parts based on the time series. For example, the training data may include input (x) data is used to make prediction, and targeted output (y) data is a desired output and used for calculating the error loss to tune a ML model. Examples generate the training data using the historical data.

The percentages are calculated based on a respective amount of desired output access data (number of accesses) by a respective region of the first-sixth regions, to a total number of output access data (total number of accesses) accesses to the data shard from all of the first-sixth regions. For example, output access data from the first region comprises 40% (0.4) of the total amount of output access data to the data shard as shown at first portion 132a. Output access data from the second region comprises 30% (0.3) of the total amount of output access data to the data shard as shown at second portion 132b. Output access data from the third region comprises 20% (0.2) of the total amount of output access data to the data shard as shown at third portion 132c. Output access data from the fourth region comprises 4% (0.04) of the total amount of output access data to the data shard as shown at fourth portion 132d. Output access data from the fifth region comprises 3% (0.03) of the total amount of output access data to the data shard as shown at fifth portion 132e. Output access data from the sixth region comprises 3% (0.03) of the total amount of output access data to the data shard as shown at sixth portion 132f.

The ML model then sorts (ranks) the first-sixth regions 132a-132f from the highest output access data (represented by the percentages in the decimal formats) to the lowest access number. In this example, higher percentages are assigned higher ranks. Thus, the first region is ranked sixth, the second region is ranked fifth, the third region is ranked fourth, the fourth region is ranked third, and the fifth region and the sixth region are tied for first.

For the classification approach, the ML model does not predict the access number or access percentage but the encoded value. If the encoded value is positive, then the shard will be placed in the corresponding region. Otherwise, the shard will be bypassed for that region. Doing so will resolve the error propagation error.

The ML model may further generate a threshold 134 (e.g., a target percentile). A number of regions that cumulatively have a total below the threshold 134 (e.g., a cumulative total of percentages of the regions meets or is below the threshold) may be selected for shard replication. Regions that exceed the cumulative total and ranked below the threshold 134 are not selected for shard replication. The threshold value is not a constant value and tunable based on a desired latency sensitivity level for the first-sixth regions.

The cumulative total includes a summation of a percentage of a particular region at a particular rank, and all percentages of region ranked above the particular region. In this example, six is the highest rank and one is the lowest rank. Thus, the cumulative total at the third region is the percentage (0.2) of the third region, the percentage (0.3) of the second region and the percentage of the first region (0.4), or 0.9. The cumulative total at the fourth region is the summation of the percentage at the fourth region (0.04), the percentage at the third region (0.2), the percentage (0.3) of the second region and the percentage (0.4) of the first region, or 0.94.

Thus, firstly, the first-sixth regions will be sorted based on the access values in descending order. Secondly, the access values of regions are normalized in the percentages. Thirdly, the threshold (%) is predefined (e.g., 90%) in the example. Regions may be included in shard placement when the cumulative access value is equal to or below the threshold.

The threshold 134 may be flexible and based on a number of different parameters. For example, the threshold 134 may be a balance between latency expectations and computing resource usage. Some examples achieve resource usage saving without sacrificing the end-to-end latency. The threshold value can quantify the percentage of the traffic that is covered within the region(s) and is evaluated by the latency-sensitive level of the service. Thus, the increase of the threshold 134 will increase the number of the replications. As shown in FIG. 2, the increase of the threshold 134 will shift the threshold 134 to the right covering more regions. The threshold 134 value should satisfy the latency exception first, then secondly consider the resource usage saving.

In this example, the threshold may be set to 0.9. The highest ranked region, the first region (rank 6), is selected and is determined to be below the threshold. The next highest ranked region, the second region (rank 5), is then analyzed. The cumulative total of the percentages (0.4+0.3) of the first and second region is 0.7, and is therefore less than 0.9. Thus, the cumulative total of the percentages of the first and second region does not exceed 0.9. Thus, the next highest ranked region, the third region (rank 4) is then analyzed. The cumulative total (0.4+0.3+0.2) of the first, second and third regions is 0.9 which is equal to the threshold 134. Thus, the cumulative total of the first, second and third regions does not exceed the threshold, and is equal to the threshold. At this point, it is apparent that the cumulative total (0.4+0.3+0.2+0.04) of the next highest region, the fourth region (rank 3), will be above the threshold 134. Thus, the ML models may iteratively analyze the first-sixth regions to identify a subset of the regions that have a cumulative total that is as close as possible to the threshold 134 without exceeding the threshold 134. Thus, the ML model may identify which regions of the first-sixth regions have cumulative totals that do not exceed the threshold 134, which in this example is the first, second and third regions.

An encoded data structure 136 is generated based on the above analysis. The first, second and third regions have a cumulative access percentages that meets the threshold (e.g., a target percentile 0.9). Therefore, the first, second and third regions are encoded as a rank of the respective regions. For example, the first region is assigned a value of 6 (ranked sixth), the second region is assigned a value of 5 (ranked fifth) and the third region is assigned a value of 4 (ranked fourth). For the fourth-sixth regions, that should not receive a replica of the data shard, are assigned access numbers are encoded as negative numbers (e.g., −1). For example, the fourth-sixth regions are assigned a same negative value (e.g., −1). In some examples, the first-third regions may be assigned negative numbers (representing ranks) and the fourth-sixth regions may be assigned positive numbers. In some examples, all of the first-sixth regions may be assigned positive or negative values, with the fourth-sixth regions being assigned a same value to connotate that the fourth-sixth region have not been selected for replication of the data shard.

Thus, decorrelated encoding values are as shown in the encoded data structure 136. The first region is assigned a value of 6 in entry 136a. The second region is assigned a value of 5 in entry 136b. The third region is assigned a value of 4 in entry 136c. The fourth-sixth regions are each assigned a value of −1 in entries 136d, 136e, 136f. The first-third regions are assigned positive values and rank to indicate that the first-third regions are to receive replicas of the data shard 204. The encoded data structure 136 represents decorrelation encoding values.

Thus, instead of encoding the output as +1/−1 values (e.g., +1 corresponds to data replication for a region and a −1 corresponds to no data replication for a region), the decorrelation encoding values (6,5,4, and −1) will be used as the output format of the ML model (e.g., particularly in the training phase). Compared to the +1/−1 values, the decorrelation encoding values may correspond to the priority of a respective region of the first-sixth regions that selected for shard placement of the data shard. The decorrelation encoding described above achieves a smoothness of output to reduce the training and inference effort on unnecessary details compared to using access values or access ratios. Furthermore, to increase the reliability of the smart replication, the small negative value, −1, is used for encoding the regions that may be skipped for the shard replication of the data shard.

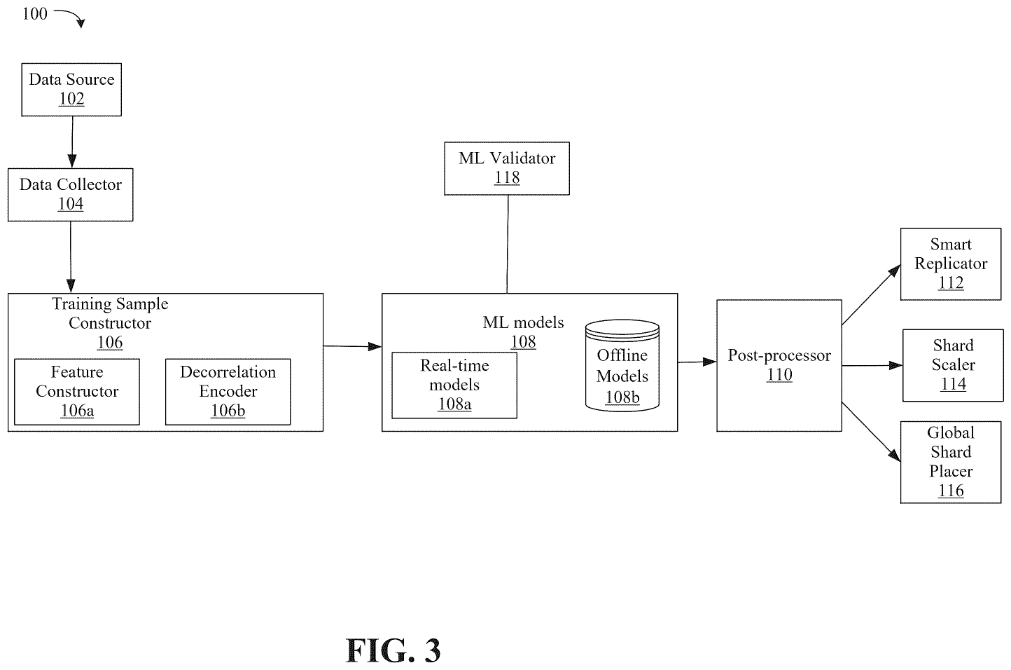

Turning now to FIG. 3, an exemplary ML framework 100 to enhance customization of the training samples, ML models and ML prediction for different applications is illustrated. One or more aspects of exemplary ML framework 100 may be implemented as part of and/or in conjunction with the process 200 (FIGS. 1 and 2). ML framework 100 may be implemented in a computing device, computing system (e.g., hardware, configurable logic, fixed-function logic hardware, at least one computer readable storage medium comprising a set of instructions for execution, etc.).

The ML framework 100 may be continuously developed, refactored, re-trained and enhanced as more data (e.g., applications/projects) becomes available. The data source 102 may receive and store data. That is, machine learning is a data driven technique, and the data source 102 is a component of generating and saving the data. For achieving effective model training of the ML models 108, the data source 102 contains data for the prediction task (e.g., data shard placement) and may be updated in real-time.

A data collector 104 is provided. Loading all data from the data source 102 may be unnecessary and also time-consuming. Therefore, the data collector 104 may customize data retrieval and retrieve dedicated data for ML model training. In such a case, the data to execute the ML-prediction based smart data shard replication is the access numbers of data shards in different regions.

The training sample constructor 106 may include a feature constructor 106a and a decorrelation encoder 106b. The data of the data source 102 may be unstructured and cannot be directly used for training samples. The training sample constructor 106 may formalize the data for model training. In some examples, the data is in the time series based and typically used for training a machine learning (ML) model. As noted above, examples formulate a smart replication problem as the classification problem. Thus, to formulate the replication analysis as a classification, examples include a feature constructor 106a and a decorrelation encoder 106b to translate data to fit a dedicated ML solution formulation, while considering reducing the training overhead to achieve expected performance.

ML models 108 include different real-time models 108a (e.g., ML applications have different demands from the ML models). The real-time models 108a allows a user to develop and customize dedicated models for a specific application. Examples provide a framework to provide optional training formats in real-time training or offline training.

For some applications, such as intelligent data shard replication, real-time training may provide enhanced results relative to offline training. For example, data shard replication operates with enhanced efficiency when the data shard replication is executed with enhanced responsiveness to the dynamic change environment. Thus, some examples may retrain ML models, such as ML model 206 (FIG. 1), in real-time and based on current data. For example, real-time training may be beneficial when an ML model operates in a dynamic and changing environment (e.g., data is changed or modified rapidly). Instead of querying and loading preserved and stored ML models, some examples may train the ML models in real-time with small training overhead (e.g., minutes) by embedding into the application using the up-to-date data.

For some applications, it may be preferable to use a deep learning model as the ML model. In such cases, offline training may be preferable. For example, the offline models 108b may be utilized. If applications do not have strict guidelines about reacting to the dynamic environment, the offline models 108b may be utilized. Such examples may spend longer amounts of time, such as hours or days, on the training to get an expected ML model. The ML model may be maintained for querying and may have an efficient way to do the refreshment.

When an increased service level is desired, a single model may no longer satisfy the expected demand of the increased service level. Some examples include ensemble models. In doing so, some examples may employ a hybrid model, in which some models are trained offline, and some are dynamically trained in real-time to allow users to develop or customize the hybrid real-time and offline models for some complicated ML applications.

A post processor 110 is further provided. The output from the ML models 108 may not be directly used by some applications. Users may customize the predictions of the output used by the ML models 108. In some examples, the optimal decorrelated encoding values will be predictive outputs by the ML models 108 (e.g., K-Nearest Neighbors (KNN) models). For example, regions with the positive value will have a data shard. For enhanced shard placement, the decision making will be the union of the shard placements in a predictive window. The ML model 206 may be one of the ML models 108.

The ML Validator 118 may test if an update is valid such as the model input/output and model selection. For the real-time models 108a, users may generate success performance metrics instead of the classification accuracy, precision or recall, which may be developed in the ML Validator 118. Some examples may identify the replicas number used by the ML-prediction based smart replication to target the expected latency.

A smart replicator 112 may determine the regions that are to store the shard to make sure the shard will cover a number of accesses as close as possible. The smart replicator 112 may also determine which regions should receive data shard replicas. A shard scaler 114 may generate replicas of a data shard, and determine the number of the replicas for the shard that will be placed in a particular region to balance the read traffic. Global shard placer 116 places the shards according to the decisions of the smart replicator 112 and the shard scaler 114.

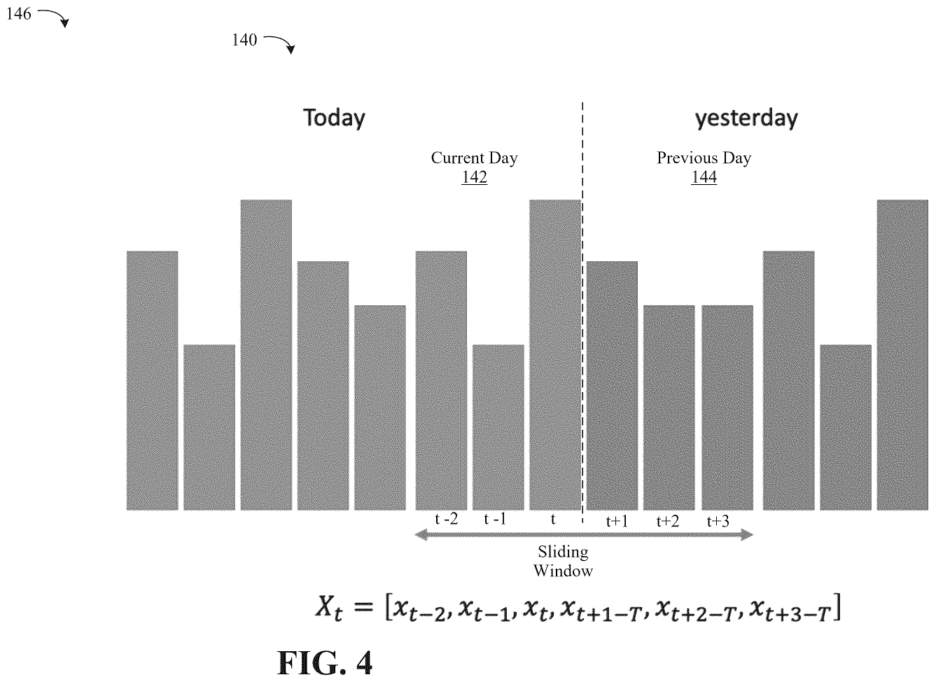

Turning now to FIG. 4, a process 146 to use the access data to construct an input (X) of a designed ML model. A feature data set 140 is illustrated. One or more aspects of the process 146 may be implemented as part of and/or in conjunction with the process 200 (FIGS. 1 and 2) and/or exemplary ML framework 100 (FIG. 3). Process 146 may be implemented in a computing device, computing system (e.g., hardware, configurable logic, fixed-function logic hardware, at least one computer readable storage medium comprising a set of instructions for execution, etc.).

Several factors affect the predictive performance of a classification based model. Feature selection is one of the factors, particularly in the context of machine and/or deep learning. High-quality features may significantly reduce the training and inference overhead for a ML model to achieve the expected performance.

In the smart replication, the output of the classification model, such as ML model 206 (FIG. 1), is to determine if a region may be bypassed or included for shard placement at a future time. From a derived optimal solution, examples may determine an access number at a future time based on a sliding window that includes future time windows. Future information may not be used to construct the feature, so the mirror window concept is to formulate the feature for a specific data point.

For example, the optimal solution to the shard placement for a region at a certain time is highly dependent on the recent access pattern. For a time “t.” the observations and/or features used to predict the shard placement for the region are the access numbers at time window [t−2, t−1, t, t+1, t+2, t+3]. The future access patterns at times t+1, t+2, t+3 are unknown and replaced by values from a previous window (e.g., twenty-four hours prior). Thus the time window is updated as [t−2, t−1, t, t+1−T, t+2−T, t+3−T] where T is one day (e.g., 24 hours). Thus, a sliding window encompasses the current day 142 and a previous day 144. Mathematically, a single input data point at time t is shown in FIG. 4. Thus, some examples apply a sliding window to a set of numbers of accesses to identify the different numbers of accesses. The sliding window extends over a period of time that includes a first portion from a first day, and a second portion from a second day.

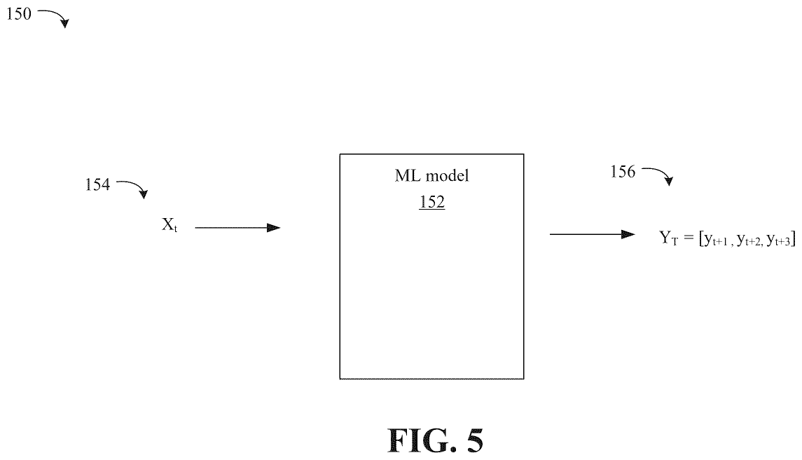

FIG. 5 illustrates a ML inference process 150. One or more aspects of the ML inference process 150 may be implemented as part of and/or in conjunction with the process 200 (FIGS. 1 and 2), exemplary ML framework 100 (FIG. 3) and/or process 146 (FIG. 4). The ML inference process 150 may be implemented in a computing device, computing system (e.g., hardware, configurable logic, fixed-function logic hardware, at least one computer readable storage medium comprising a set of instructions for execution, etc.).

An input Xₜ may be generated. For example, Xₜ may be generated based on process 146 (FIG. 4) and may include the access numbers within the sliding window, while excluding access numbers outside the sliding window. The access numbers may include accesses to different regions.

After formatting and obtaining the input data format according to the ML inference process 150, an ML model 152 may be applied to perform the classification task by predicting the decorrelated encoding values Y_{T}=(yₜ₊₁, yₜ₊₂, yₜ₊₃) for a replica in a future window (e.g., future hours). Yr is a vector of a predictive encoding values at time t. The decorrelated encoding values may be similar to the encoded data structure 136 (FIG. 2). A region may be classified as “including a data shard” in the shard placement at time t+1 if the yₜ₊₁ is positive, and classified as “skip” if yₜ₊₁ is negative. In some examples, different values (e.g., a negative value, value above a threshold, etc.) may indicate that a shard is to be placed in a region, and different values (e.g., a positive value, value below a threshold, etc.) indicates that a shard is not to be placed in the region.

For the training phase, the overhead may be considered light due to the formulation of the classification approach noted above. Instead of the offline training, examples adopt online training by integrating the ML-prediction based smart replication into a current automation framework. There may be several classification based machine models. In ML, deep learning may give a more accurate prediction, but has a greater training overhead and increases the maintenance effort on the model preservation. Thus some examples use a lightweight ML model.

A light-weight model may be incorporated since the analysis and formulation of the classification problem makes it possible to provide effective information for the learning model to perform classification. Doing so reduces the learning effort on feature selection. Hence, the light-weight model is good to choose. KNN may be an initial starting point. Due to KNN's non-parametric nature, a KNN may not operate with a large training overhead to optimize the model for classification. Some examples may operate with around six minutes data query, training, and giving shard placement predictions while targeting the expected latency percentile.

A “regression model for the classification task” is applied for the model selection. The output format of the classification model may be the discrete number or the label. Imbalanced data may occur in a dataset if labeling the data using +1/−1 or decorrelated encoding for the classification model. The prediction performance may be negatively impacted due to the uneven distribution of observations. Based on the formulation of the smart replication problem and the decorrelated encoding process described herein, the imbalanced data issue may be addressed by using a regression model for the classification task. Thus, the ML model 152 may receive a training input 154, and output region placement decorrelated encodings 156.

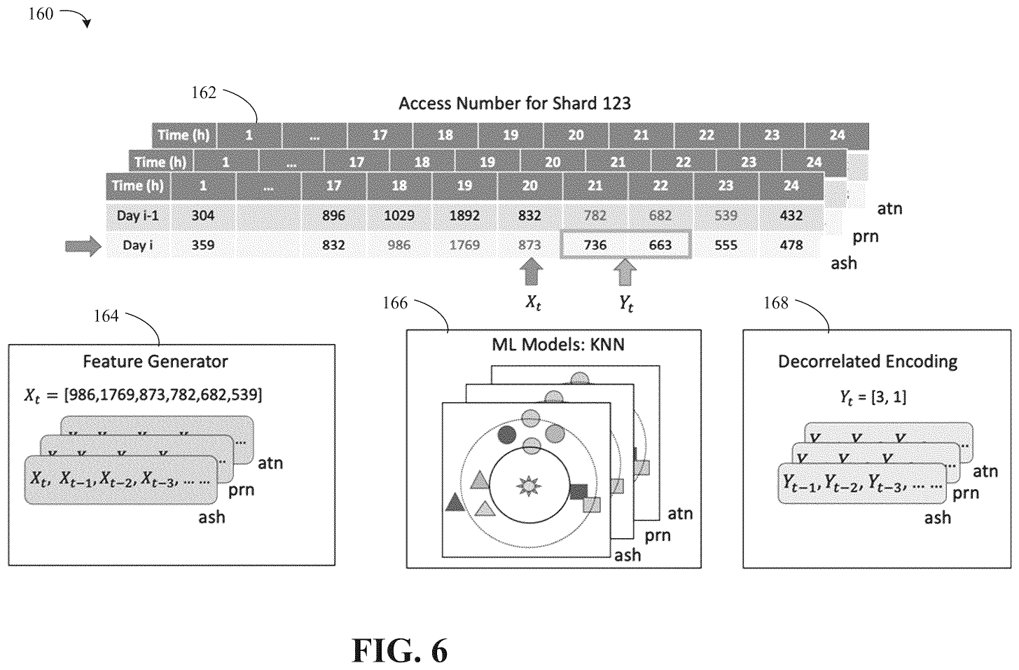

FIG. 6 illustrates a training phase 160 for the ML model (152 in FIG. 5) used for smart replication. One or more aspects of the training phase 160 may be implemented as part of and/or in conjunction with the process 200 (FIGS. 1 and 2), exemplary ML framework 100 (FIG. 3), process 146 (FIG. 4) and/or ML inference process 150 (FIG. 5). The training phase 160 may be implemented in a computing device, computing system (e.g., hardware, configurable logic, fixed-function logic hardware, at least one computer readable storage medium comprising a set of instructions for execution, etc.).

The data 162 includes an access number for shard 123 at different regions ash, prn, atn and times for a forty-eight hour historical data including day i−1 and day i. The example presents the access number in 1-hour granularity of the shard 123 at regions ash, prn, and atn.

The input is the feature constructed by a mirror window at time Xₜ on day i centered around Xₜ. The example uses a plus/minus three hours window to construct a feature vector (e.g., windowed data). Since future access values (736, 663, 555) at times Yₜ cannot be used (since those access values have not occurred), the plus three-hour window uses the access numbers (782, 682, 539) on the previous day i−1 as discussed above. Hence, at the time t, examples cannot use the future information for feature construction, so Xₜ=[986, 1769, 873, 782, 682, 539]. The input samples are the recent data in one or two days from a present time.

The output for Xₜ may be constructed by a predictive window (e.g., 2 hours) for the predicted access numbers. The example above is using access number [736, 663] at t+1 and t+2 for encoding as the output. Xₜ may be the input of the model and the Yₜ is the output of the model. For this example, Yₜ is the encoded value of the access numbers [736, 663] by using the decorrelated technique introduced described above during training. [736, 663] is the access value at t+1 and t+2 of a region, the decorrelated approach will interact with the other regions to calculate the encoded value.

The approach is elaborated as below. First, the regions will be sorted based on the access values in the descending order. Second, the access values of regions are normalized in the percentage. Thirdly, the threshold (%) is predefined like 90% in the example, the regions will be included in the placement when the cumulative value is below the threshold. The feature generator 164 may extract the feature vectors from the data 162, and provides the feature vectors to the ML models 166.

The ML models 166 may generate the decorrelated encoding 168. The decorrelated encoding 168 may summarize the output values in all regions ash, prn, atn and provide the encoding values (e.g., Yₜ=[3,1] for ash) for every region ash, prn, atn, similarly to as previously discussed.

Access patterns behave differently. By maintaining a simple ML models in the ML models 166 (e.g., “Keep model simple”) allows examples to have a dedicated model for each shard-region (replicas). Such a design also ensures the independence of all shard-region pairs to avoid the error propagation. By this setting, the models for each pair can be trained in parallel, which can significantly accelerate the process.

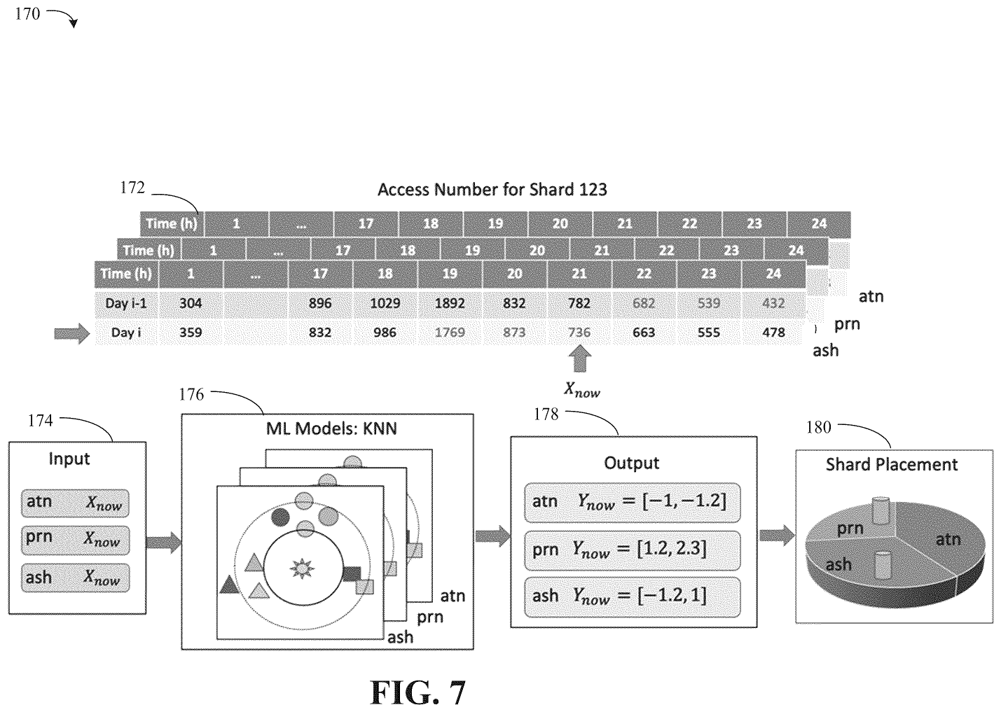

Turning now to FIG. 7, an inference process 170 is illustrated. One or more aspects of the inference process 170 may be implemented as part of and/or in conjunction with the process 200 (FIGS. 1 and 2), exemplary ML framework 100 (FIG. 3), process 146 (FIG. 4), ML inference process 150 (FIG. 5) and/or training phase 160 (FIG. 6). The inference process 170 may be implemented in a computing device, computing system (e.g., hardware, configurable logic, fixed-function logic hardware, at least one computer readable storage medium comprising a set of instructions for execution, etc.). The inference process 170 may be considered a more detailed explanation of ML inference process 150 (FIG. 5).

In the inference process 170, models are obtained in the training phase, such as training phase 160. The example shows that the smart replication is activated for shard placement at time t=21 at X_{now} in data 172. The ML models 176 may provide the prediction Y_{now} in a window t=[22, 23].

The input 174 X_{now} for ash=[1769, 873, 736, 682, 539, 432] based on a sliding window as discussed above. The ML models 176 receive the input 174, and generate output 178. The output 178 Y_{now} for region ash=[−1.2, 1]. The post process 180 includes shard placement in which ML models 176 suggest including the ash in the shard placement in the future 1 hour (t+1) and skipping the shard in the region ash in the following one hour (t+2). Thus, the output values may not necessarily indicate a rank and/or predicted number of accesses, but are a value (e.g., positive value) indicating whether a shard should be placed in a respective region or a value (e.g., a negative value) indicating whether a shard should not be placed in a respective region.

The smart replication may execute hourly for shard placement but may fail due to some reasons and skip the placement. For safety, the decision for this run is to union the placements, which turns out to include the ash.

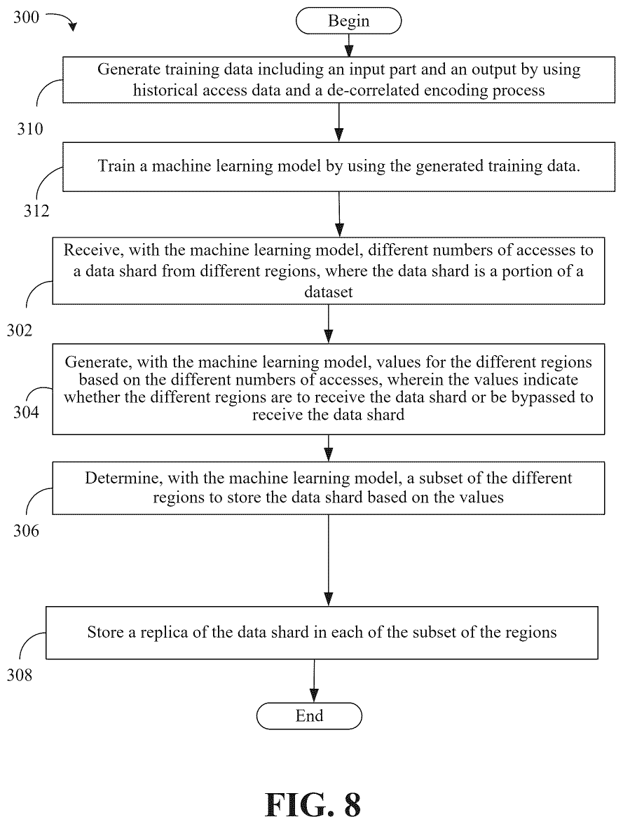

FIG. 8 illustrates a method 300 to train a machine learning model and determine data shard placement. One or more aspects of method 300 may be implemented as part of and/or in conjunction with the process 200 (FIGS. 1 and 2), exemplary ML framework 100 (FIG. 3), process 146 (FIG. 4), ML inference process 150 (FIG. 5), training phase 160 (FIG. 6) and/or an inference process 170 (FIG. 7). Method 300 may be implemented in a computing device, computing system (e.g., hardware, configurable logic, fixed-function logic hardware, at least one computer readable storage medium comprising a set of instructions for execution, etc.).

Illustrated processing block 310 generates training data including an input part and an output by using historical access data and a de-correlated encoding process. Illustrated processing block 312 trains a machine learning model by using the generated training data.

During inference, illustrated processing block 302 receives, with the machine learning model, different numbers of accesses to a data shard from different regions, where the data shard is a portion of a dataset. Illustrated processing block 304 generates, with the machine learning model, values for the different regions based on the different numbers of accesses, where the values indicate whether the different regions are to receive the data shard or be bypassed to receive the data shard. Illustrated processing block 306 determines, with the machine learning model, a subset of the different regions to store the data shard based on the values. Notably, the values may be identifications of whether the different regions receive the data shard, may be different from the rank of the different regions and the number of predicted accesses. That is, the machine learning model identifies where to place data shards, rather than predicting the future number of accesses and/or a rank of the different regions. For the training process, the positive values correspond to the rank. For the inference process, the positive values are predictive ranks. Illustrated processing block 308 stores a replica of the data shard in each of the subset of the regions.

In some examples, the method 300 applies a sliding window to a set of numbers of accesses to identify the different numbers of accesses, where the sliding window extends over a period of time that includes a first portion of the set of the numbers of accesses from a first day, and a second portion of the set of the numbers of accesses from a second day. The different numbers of accesses include the first portion and the second portion.

In some examples, method 300 identifies, during the training process of the machine learning model, prediction values of the different regions, where the prediction values are associated with a future number of predicted accesses, orders the different regions according to the prediction values into an arrangement that represents the ranks, identifies first regions of the different regions that are arranged below a threshold according to the order, and assigns each of the first regions a different first value, where the different first values are one of positive numbers or negative numbers. In some examples, the method 300 the first values represent the ranks of the first regions. In some examples, during a training process of the machine learning model, the method 300 identifies second regions of the different regions that are arranged above the threshold according to the order, and assigning each of the second regions a second value, where the second values are the other of the positive numbers or the negative numbers. In some examples, all of the second values are the same value. In some examples, the method 300 determines that the subset of the different regions includes the first regions, and determines that the second regions are to be bypassed for inclusion in the subset of the different regions.

### System Overview

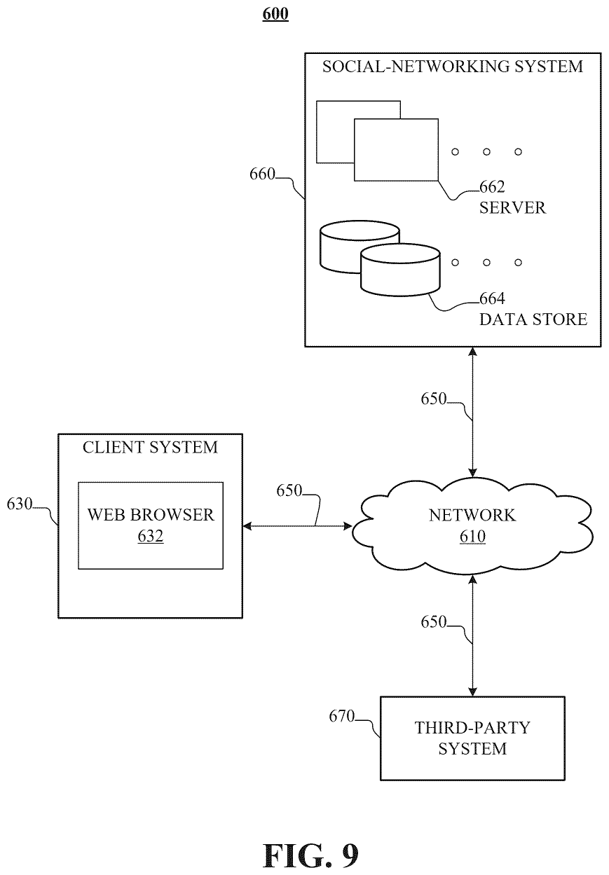

FIG. 9 illustrates an example network environment 600 associated with a social-networking system. Network environment 600 may implement one or more aspects the process 200 (FIGS. 1 and 2), exemplary ML framework 100 (FIG. 3), process 146 (FIG. 4), ML inference process 150 (FIG. 5), training phase 160 (FIG. 6), an inference process 170 (FIG. 7) and/or method 300 (FIG. 8) already discussed.

Network environment 600 includes a client system 630, a social-networking system 660, and a third-party system 670 connected to each other by a network 610. Although FIG. 9 illustrates a particular arrangement of client system 630, social-networking system 660, third-party system 670, and network 610, this disclosure contemplates any suitable arrangement of client system 630, social-networking system 660, third-party system 670, and network 610. As an example and not by way of limitation, two or more of client system 630, social-networking system 660, and third-party system 670 may be connected to each other directly, bypassing network 610. As another example, two or more of client system 630, social-networking system 660, and third-party system 670 may be physically or logically co-located with each other in whole or in part. Moreover, although FIG. 9 illustrates a particular number of client systems 630, social-networking systems 660, third-party systems 670, and networks 610, this disclosure contemplates any suitable number of client systems 630, social-networking systems 660, third-party systems 670, and networks 610. As an example and not by way of limitation, network environment 600 may include multiple client system 630, social-networking systems 660, third-party systems 670, and networks 610.

This disclosure contemplates any suitable network 610. As an example and not by way of limitation, one or more portions of network 610 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 610 may include one or more networks 610.

Links 650 may connect client system 630, social-networking system 660, and third-party system 670 to communication network 610 or to each other. This disclosure contemplates any suitable links 650. In particular examples, one or more links 650 include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular examples, one or more links 650 each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 650, or a combination of two or more such links 650. Links 650 may not necessarily be the same throughout network environment 600. One or more first links 650 may differ in one or more respects from one or more second links 650.

In particular examples, client system 630 may be an electronic device including hardware, software, or embedded logic components or a combination of two or more such components and capable of carrying out the appropriate functionalities implemented or supported by client system 630. As an example and not by way of limitation, a client system 630 may include a computer system such as a desktop computer, notebook or laptop computer, netbook, a tablet computer, e-book reader, GPS device, camera, personal digital assistant (PDA), handheld electronic device, cellular telephone, smartphone, augmented/virtual reality device, other suitable electronic device, or any suitable combination thereof. This disclosure contemplates any suitable client systems 630. A client system 630 may enable a network user at client system 630 to access network 610. A client system 630 may enable its user to communicate with other users at other client systems 630.

In particular examples, client system 630 may include a web browser 632, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user at client system 630 may enter a Uniform Resource Locator (URL) or other address directing the web browser 632 to a particular server (such as server 662, or a server associated with a third-party system 670), and the web browser 632 may generate a Hyper Text Transfer Protocol (HTTP) request and communicate the HTTP request to server. The server may accept the HTTP request and communicate to client system 630 one or more Hyper Text Markup Language (HTML) files responsive to the HTTP request. Client system 630 may render a webpage based on the HTML files from the server for presentation to the user. This disclosure contemplates any suitable webpage files. As an example and not by way of limitation, webpages may render from HTML files, Extensible Hyper Text Markup Language (XHTML) files, or Extensible Markup Language (XML) files, according to particular desires. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage files (which a browser may use to render the webpage) and vice versa, where appropriate.

In particular examples, social-networking system 660 may be a network-addressable computing system that may host an online social network. Social-networking system 660 may generate, store, receive, and send social-networking data, such as, for example, user-profile data, concept-profile data, social-graph information, or other suitable data related to the online social network. Social-networking system 660 may be accessed by the other components of network environment 600 either directly or via network 610. As an example and not by way of limitation, client system 630 may access social-networking system 660 using a web browser 632, or a native application associated with social-networking system 660 (e.g., a mobile social-networking application, a messaging application, another suitable application, or any combination thereof) either directly or via network 610. In particular examples, social-networking system 660 may include one or more servers 662. Each server 662 may be a unitary server or a distributed server spanning multiple computers or multiple datacenters. Servers 662 may be of various types, such as, for example and without limitation, web server, news server, mail server, message server, advertising server, file server, application server, exchange server, database server, proxy server, another server suitable for performing functions or processes described herein, or any combination thereof. In particular examples, each server 662 may include hardware, software, or embedded logic components or a combination of two or more such components for carrying out the appropriate functionalities implemented or supported by server 662. In particular examples, social-networking system 660 may include one or more data stores 664. Data stores 664 may be used to store various types of information. In particular examples, the information stored in data stores 664 may be organized according to specific data structures. In particular examples, each data store 664 may be a relational, columnar, correlation, or other suitable database. Although this disclosure describes or illustrates particular types of databases, this disclosure contemplates any suitable types of databases. Particular examples may provide interfaces that enable a client system 630, a social-networking system 660, or a third-party system 670 to manage, retrieve, modify, add, or delete, the information stored in data store 664.

In particular examples, social-networking system 660 may store one or more social graphs in one or more data stores 664. In particular examples, a social graph may include multiple nodes—which may include multiple user nodes (each corresponding to a particular user) or multiple concept nodes (each corresponding to a particular concept)—and multiple edges connecting the nodes. Social-networking system 660 may provide users of the online social network the ability to communicate and interact with other users. In particular examples, users may join the online social network via social-networking system 660 and then add connections (e.g., relationships) to a number of other users of social-networking system 660 to whom they want to be connected. Herein, the term “friend” may refer to any other user of social-networking system 660 with whom a user has formed a connection, association, or relationship via social-networking system 660.

In particular examples, social-networking system 660 may provide users with the ability to take actions on various types of items or objects, supported by social-networking system 660. As an example and not by way of limitation, the items and objects may include groups or social networks to which users of social-networking system 660 may belong, events or calendar entries in which a user might be interested, computer-based applications that a user may use, transactions that allow users to buy or sell items via the service, interactions with advertisements that a user may perform, or other suitable items or objects. A user may interact with anything that is capable of being represented in social-networking system 660 or by an external system of third-party system 670, which is separate from social-networking system 660 and coupled to social-networking system 660 via a network 610.

In particular examples, social-networking system 660 may be capable of linking a variety of entities. As an example and not by way of limitation, social-networking system 660 may enable users to interact with each other as well as receive content from third-party systems 670 or other entities, or to allow users to interact with these entities through an application programming interfaces (API) or other communication channels.

In particular examples, a third-party system 670 may include one or more types of servers, one or more data stores, one or more interfaces, including but not limited to APIs, one or more web services, one or more content sources, one or more networks, or any other suitable components, e.g., that servers may communicate with. A third-party system 670 may be operated by a different entity from an entity operating social-networking system 660. In particular examples, however, social-networking system 660 and third-party systems 670 may operate in conjunction with each other to provide social-networking services to users of social-networking system 660 or third-party systems 670. In this sense, social-networking system 660 may provide a platform, or backbone, which other systems, such as third-party systems 670, may use to provide social-networking services and functionality to users across the Internet.

In particular examples, a third-party system 670 may include a third-party content object provider. A third-party content object provider may include one or more sources of content objects, which may be communicated to a client system 630. As an example and not by way of limitation, content objects may include information regarding things or activities of interest to the user, such as, for example, movie show times, movie reviews, restaurant reviews, restaurant menus, product information and reviews, or other suitable information. As another example and not by way of limitation, content objects may include incentive content objects, such as coupons, discount tickets, gift certificates, or other suitable incentive objects.

In particular examples, social-networking system 660 also includes user-generated content objects, which may enhance a user's interactions with social-networking system 660. User-generated content may include anything a user may add, upload, send, or “post” to social-networking system 660. As an example and not by way of limitation, a user communicates posts to social-networking system 660 from a client system 630. Posts may include data such as status updates or other textual data, location information, photos, videos, links, music or other similar data or media. Content may also be added to social-networking system 660 by a third-party through a “communication channel,” such as a newsfeed or stream.

In particular examples, social-networking system 660 may include a variety of servers, sub-systems, programs, modules, logs, and data stores. In particular examples, social-networking system 660 may include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile store, connection store, third-party content store, or location store. Social-networking system 660 may also include suitable components such as network interfaces, security mechanisms, load balancers, failover servers, management-and-network-operations consoles, other suitable components, or any suitable combination thereof. In particular examples, social-networking system 660 may include one or more user-profile stores for storing user profiles. A user profile may include, for example, biographic information, demographic information, behavioral information, social information, or other types of descriptive information, such as work experience, educational history, hobbies or preferences, interests, affinities, or location. Interest information may include interests related to one or more categories. Categories may be general or specific. As an example and not by way of limitation, if a user “likes” an article about a brand of shoes the category may be the brand, or the general category of “shoes” or “clothing.” A connection store may be used for storing connection information about users. The connection information may indicate users who have similar or common work experience, group memberships, hobbies, educational history, or are in any way related or share common attributes. The connection information may also include user-defined connections between different users and content (both internal and external). A web server may be used for linking social-networking system 660 to one or more client systems 630 or one or more third-party system 670 via network 610. The web server may include a mail server or other messaging functionality for receiving and routing messages between social-networking system 660 and one or more client systems 630. An API-request server may allow a third-party system 670 to access information from social-networking system 660 by calling one or more APIs. An action logger may be used to receive communications from a web server about a user's actions on or off social-networking system 660. In conjunction with the action log, a third-party-content-object log may be maintained of user exposures to third-party-content objects. A notification controller may provide information regarding content objects to a client system 630. Information may be pushed to a client system 630 as notifications, or information may be pulled from client system 630 responsive to a request received from client system 630. Authorization servers may be used to enforce one or more privacy settings of the users of social-networking system 660. A privacy setting of a user determines how particular information associated with a user may be shared. The authorization server may allow users to opt in to or opt out of having their actions logged by social-networking system 660 or shared with other systems (e.g., third-party system 670), such as, for example, by setting appropriate privacy settings. Third-party-content-object stores may be used to store content objects received from third parties, such as a third-party system 670. Location stores may be used for storing location information received from client systems 630 associated with users. Advertisement-pricing modules may combine social information, the current time, location information, or other suitable information to provide relevant advertisements, in the form of notifications, to a user.

### Social Graphs

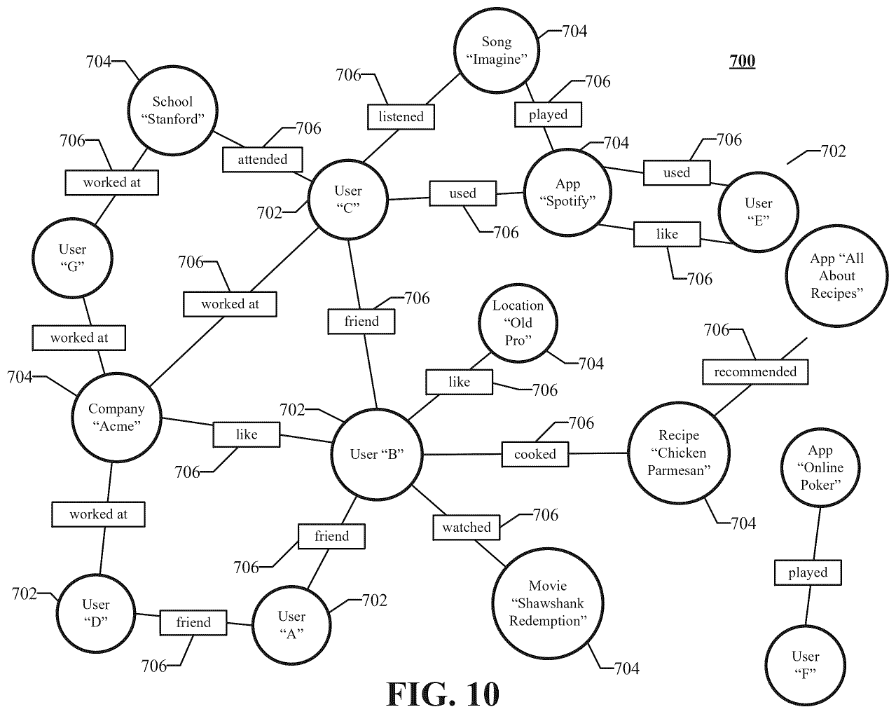

FIG. 10 illustrates example social graph 700. In some examples, the process 200 (FIGS. 1 and 2), exemplary ML framework 100 (FIG. 3), process 146 (FIG. 4), ML inference process 150 (FIG. 5), training phase 160 (FIG. 6) and/or an inference process 170 (FIG. 7) and/or method 300 (FIG. 8) already discussed may access social graph 700 to implement one or more aspects. In particular examples, social-networking system 660 may store one or more social graphs 700 in one or more data stores. In particular examples, social graph 700 may include multiple nodes—which may include multiple user nodes 702 or multiple concept nodes 704—and multiple edges 706 connecting the nodes. Each node may be associated with a unique entity (i.e., user or concept), each of which may have a unique identifier (ID), such as a unique number or username. Example social graph 700 illustrated in FIG. 10 is shown, for didactic purposes, in a two-dimensional visual map representation. In particular examples, a social-networking system 660, client system 630, or third-party system 670 may access social graph 700 and related social-graph information for suitable applications. The nodes and edges of social graph 700 may be stored as data objects, for example, in a data store (such as a social-graph database). Such a data store may include one or more searchable or queryable indexes of nodes or edges of social graph 700.

In particular examples, a user node 702 may correspond to a user of social-networking system 660. As an example and not by way of limitation, a user may be an individual (human user), an entity (e.g., an enterprise, business, or third-party application), or a group (e.g., of individuals or entities) that interacts or communicates with or over social-networking system 660. In particular examples, when a user registers for an account with social-networking system 660, social-networking system 660 may create a user node 702 corresponding to the user, and store the user node 702 in one or more data stores. Users and user nodes 702 described herein may, where appropriate, refer to registered users and user nodes 702 associated with registered users. In addition or as an alternative, users and user nodes 702 described herein may, where appropriate, refer to users that have not registered with social-networking system 660. In particular examples, a user node 702 may be associated with information provided by a user or information gathered by various systems, including social-networking system 660. As an example and not by way of limitation, a user may provide his or her name, profile picture, contact information, birth date, sex, marital status, family status, employment, education background, preferences, interests, or other demographic information. In particular examples, a user node 702 may be associated with one or more data objects corresponding to information associated with a user. In particular examples, a user node 702 may correspond to one or more webpages.

In particular examples, a concept node 704 may correspond to a concept. As an example and not by way of limitation, a concept may correspond to a place (such as, for example, a movie theater, restaurant, landmark, or city); a website (such as, for example, a website associated with social-network system 660 or a third-party website associated with a web-application server); an entity (such as, for example, a person, business, group, sports team, or celebrity); a resource (such as, for example, an audio file, video file, digital photo, text file, structured document, or application) which may be located within social-networking system 660 or on an external server, such as a web-application server; real or intellectual property (such as, for example, a sculpture, painting, movie, game, song, idea, photograph, or written work); a game; an activity; an idea or theory; an object in a augmented/virtual reality environment; another suitable concept; or two or more such concepts. A concept node 704 may be associated with information of a concept provided by a user or information gathered by various systems, including social-networking system 660. As an example and not by way of limitation, information of a concept may include a name or a title; one or more images (e.g., an image of the cover page of a book); a location (e.g., an address or a geographical location); a website (which may be associated with a URL); contact information (e.g., a phone number or an email address); other suitable concept information; or any suitable combination of such information. In particular examples, a concept node 704 may be associated with one or more data objects corresponding to information associated with concept node 704. In particular examples, a concept node 704 may correspond to one or more webpages.

In particular examples, a node in social graph 700 may represent or be represented by a webpage (which may be referred to as a “profile page”). Profile pages may be hosted by or accessible to social-networking system 660. Profile pages may also be hosted on third-party websites associated with a third-party system 670. As an example and not by way of limitation, a profile page corresponding to a particular external webpage may be the particular external webpage and the profile page may correspond to a particular concept node 704. Profile pages may be viewable by all or a selected subset of other users. As an example and not by way of limitation, a user node 702 may have a corresponding user-profile page in which the corresponding user may add content, make declarations, or otherwise express himself or herself. As another example and not by way of limitation, a concept node 704 may have a corresponding concept-profile page in which one or more users may add content, make declarations, or express themselves, particularly in relation to the concept corresponding to concept node 704.

In particular examples, a concept node 704 may represent a third-party webpage or resource hosted by a third-party system 670. The third-party webpage or resource may include, among other elements, content, a selectable or other icon, or other inter-actable object (which may be implemented, for example, in JavaScript, AJAX, or PHP codes) representing an action or activity. As an example and not by way of limitation, a third-party webpage may include a selectable icon such as “like,” “check-in,” “eat,” “recommend,” or another suitable action or activity. A user viewing the third-party webpage may perform an action by selecting one of the icons (e.g., “check-in”), causing a client system 630 to send to social-networking system 660 a message indicating the user's action. In response to the message, social-networking system 660 may create an edge (e.g., a check-in-type edge) between a user node 702 corresponding to the user and a concept node 704 corresponding to the third-party webpage or resource and store edge 706 in one or more data stores.

In particular examples, a pair of nodes in social graph 700 may be connected to each other by one or more edges 706. An edge 706 connecting a pair of nodes may represent a relationship between the pair of nodes. In particular examples, an edge 706 may include or represent one or more data objects or attributes corresponding to the relationship between a pair of nodes. As an example and not by way of limitation, a first user may indicate that a second user is a “friend” of the first user. In response to this indication, social-networking system 660 may send a “friend request” to the second user. If the second user confirms the “friend request,” social-networking system 660 may create an edge 706 connecting the first user's user node 702 to the second user's user node 702 in social graph 700 and store edge 706 as social-graph information in one or more of data stores 664. In the example of FIG. 10, social graph 700 includes an edge 706 indicating a friend relation between user nodes 702 of user “A” and user “B” and an edge indicating a friend relation between user nodes 702 of user “C” and user “B.” Although this disclosure describes or illustrates particular edges 706 with particular attributes connecting particular user nodes 702, this disclosure contemplates any suitable edges 706 with any suitable attributes connecting user nodes 702. As an example and not by way of limitation, an edge 706 may represent a friendship, family relationship, business or employment relationship, fan relationship (including, e.g., liking, etc.), follower relationship, visitor relationship (including, e.g., accessing, viewing, checking-in, sharing, etc.), subscriber relationship, superior/subordinate relationship, reciprocal relationship, non-reciprocal relationship, another suitable type of relationship, or two or more such relationships. Moreover, although this disclosure generally describes nodes as being connected, this disclosure also describes users or concepts as being connected. Herein, references to users or concepts being connected may, where appropriate, refer to the nodes corresponding to those users or concepts being connected in social graph 700 by one or more edges 706. The degree of separation between two objects represented by two nodes, respectively, is a count of edges in a shortest path connecting the two nodes in the social graph 700. As an example and not by way of limitation, in the social graph 700, the user node 702 of user “C” is connected to the user node 702 of user “A” via multiple paths including, for example, a first path directly passing through the user node 702 of user “B,” a second path passing through the concept node 704 of company “Acme” and the user node 702 of user “D,” and a third path passing through the user nodes 702 and concept nodes 704 representing school “Stanford,” user “G,” company “Acme,” and user “D.” User “C” and user “A” have a degree of separation of two because the shortest path connecting their corresponding nodes (i.e., the first path) includes two edges 706.

In particular examples, an edge 706 between a user node 702 and a concept node 704 may represent a particular action or activity performed by a user associated with user node 702 toward a concept associated with a concept node 704. As an example and not by way of limitation, as illustrated in FIG. 10, a user may “like,” “attended,” “played,” “listened,” “cooked,” “worked at,” or “watched” a concept, each of which may correspond to an edge type or subtype. A concept-profile page corresponding to a concept node 704 may include, for example, a selectable “check in” icon (such as, for example, a clickable “check in” icon) or a selectable “add to favorites” icon. Similarly, after a user clicks these icons, social-networking system 660 may create a “favorite” edge or a “check in” edge in response to a user's action corresponding to a respective action. As another example and not by way of limitation, a user (user “C”) may listen to a particular song (“Imagine”) using a particular application (SPOTIFY, which is an online music application). In this case, social-networking system 660 may create a “listened” edge 706 and a “used” edge (as illustrated in FIG. 9) between user nodes 702 corresponding to the user and concept nodes 704 corresponding to the song and application to indicate that the user listened to the song and used the application. Moreover, social-networking system 660 may create a “played” edge 706 (as illustrated in FIG. 9) between concept nodes 704 corresponding to the song and the application to indicate that the particular song was played by the particular application. In this case, “played” edge 706 corresponds to an action performed by an external application (SPOTIFY) on an external audio file (the song “Imagine”). Although this disclosure describes particular edges 706 with particular attributes connecting user nodes 702 and concept nodes 704, this disclosure contemplates any suitable edges 706 with any suitable attributes connecting user nodes 702 and concept nodes 704. Moreover, although this disclosure describes edges between a user node 702 and a concept node 704 representing a single relationship, this disclosure contemplates edges between a user node 702 and a concept node 704 representing one or more relationships. As an example and not by way of limitation, an edge 706 may represent both that a user likes and has used at a particular concept. Alternatively, another edge 706 may represent each type of relationship (or multiples of a single relationship) between a user node 702 and a concept node 704 (as illustrated in FIG. 10 between user node 702 for user “E” and concept node 704 for “SPOTIFY”).

In particular examples, social-networking system 660 may create an edge 706 between a user node 702 and a concept node 704 in social graph 700. As an example and not by way of limitation, a user viewing a concept-profile page (such as, for example, by using a web browser or a special-purpose application hosted by the user's client system 630) may indicate that he or she likes the concept represented by the concept node 704 by clicking or selecting a “Like” icon, which may cause the user's client system 630 to send to social-networking system 660 a message indicating the user's liking of the concept associated with the concept-profile page. In response to the message, social-networking system 660 may create an edge 706 between user node 702 associated with the user and concept node 704, as illustrated by “like” edge 706 between the user and concept node 704. In particular examples, social-networking system 660 may store an edge 706 in one or more data stores. In particular examples, an edge 706 may be automatically formed by social-networking system 660 in response to a particular user action. As an example and not by way of limitation, if a first user uploads a picture, watches a movie, or listens to a song, an edge 706 may be formed between user node 702 corresponding to the first user and concept nodes 704 corresponding to those concepts. Although this disclosure describes forming particular edges 706 in particular manners, this disclosure contemplates forming any suitable edges 706 in any suitable manner.

### Social Graph Affinity and Coefficient

In particular examples, social-networking system 660 may determine the social-graph affinity (which may be referred to herein as “affinity”) of various social-graph entities for each other. Affinity may represent the strength of a relationship or level of interest between particular objects associated with the online social network, such as users, concepts, content, actions, advertisements, other objects associated with the online social network, or any suitable combination thereof. Affinity may also be determined with respect to objects associated with third-party systems 670 or other suitable systems. An overall affinity for a social-graph entity for each user, subject matter, or type of content may be established. The overall affinity may change based on continued monitoring of the actions or relationships associated with the social-graph entity. Although this disclosure describes determining particular affinities in a particular manner, this disclosure contemplates determining any suitable affinities in any suitable manner.

In particular examples, social-networking system 660 may measure or quantify social-graph affinity using an affinity coefficient (which may be referred to herein as “coefficient”). The coefficient may represent or quantify the strength of a relationship between particular objects associated with the online social network. The coefficient may also represent a probability or function that measures a predicted probability that a user will perform a particular action based on the user's interest in the action. In this way, a user's future actions may be predicted based on the user's prior actions, where the coefficient may be calculated at least in part on the history of the user's actions. Coefficients may be used to predict any number of actions, which may be within or outside of the online social network. As an example and not by way of limitation, these actions may include various types of communications, such as sending messages, posting content, or commenting on content; various types of observation actions, such as accessing or viewing profile pages, media, or other suitable content; various types of coincidence information about two or more social-graph entities, such as being in the same group, tagged in the same photograph, checked-in at the same location, or attending the same event; or other suitable actions. Although this disclosure describes measuring affinity in a particular manner, this disclosure contemplates measuring affinity in any suitable manner.

In particular examples, social-networking system 660 may use a variety of factors to calculate a coefficient. These factors may include, for example, user actions, types of relationships between objects, location information, other suitable factors, or any combination thereof. In particular examples, different factors may be weighted differently when calculating the coefficient. The weights for each factor may be static or the weights may change according to, for example, the user, the type of relationship, the type of action, the user's location, and so forth. Ratings for the factors may be combined according to their weights to determine an overall coefficient for the user. As an example and not by way of limitation, particular user actions may be assigned both a rating and a weight while a relationship associated with the particular user action is assigned a rating and a correlating weight (e.g., so the weights total 100%). To calculate the coefficient of a user towards a particular object, the rating assigned to the user's actions may comprise, for example, 60% of the overall coefficient, while the relationship between the user and the object may comprise 40% of the overall coefficient. In particular examples, the social-networking system 660 may consider a variety of variables when determining weights for various factors used to calculate a coefficient, such as, for example, the time since information was accessed, decay factors, frequency of access, relationship to information or relationship to the object about which information was accessed, relationship to social-graph entities connected to the object, short- or long-term averages of user actions, user feedback, other suitable variables, or any combination thereof. As an example and not by way of limitation, a coefficient may include a decay factor that causes the strength of the signal provided by particular actions to decay with time, such that more recent actions are more relevant when calculating the coefficient. The ratings and weights may be continuously updated based on continued tracking of the actions upon which the coefficient is based. Any type of process or algorithm may be employed for assigning, combining, averaging, and so forth the ratings for each factor and the weights assigned to the factors. In particular examples, social-networking system 660 may determine coefficients using machine-learning algorithms trained on historical actions and past user responses, or data farmed from users by exposing them to various options and measuring responses. Although this disclosure describes calculating coefficients in a particular manner, this disclosure contemplates calculating coefficients in any suitable manner.

In particular examples, social-networking system 660 may calculate a coefficient based on a user's actions. Social-networking system 660 may monitor such actions on the online social network, on a third-party system 670, on other suitable systems, or any combination thereof. Any suitable type of user actions may be tracked or monitored. Typical user actions include viewing profile pages, creating or posting content, interacting with content, tagging or being tagged in images, joining groups, listing and confirming attendance at events, checking-in at locations, liking particular pages, creating pages, and performing other tasks that facilitate social action. In particular examples, social-networking system 660 may calculate a coefficient based on the user's actions with particular types of content. The content may be associated with the online social network, a third-party system 670, or another suitable system. The content may include users, profile pages, posts, news stories, headlines, instant messages, chat room conversations, emails, advertisements, pictures, video, music, other suitable objects, or any combination thereof. Social-networking system 660 may analyze a user's actions to determine whether one or more of the actions indicate an affinity for subject matter, content, other users, and so forth. As an example and not by way of limitation, if a user frequently posts content related to “coffee” or variants thereof, social-networking system 660 may determine the user has a high coefficient with respect to the concept “coffee”. Particular actions or types of actions may be assigned a higher weight and/or rating than other actions, which may affect the overall calculated coefficient. As an example and not by way of limitation, if a first user emails a second user, the weight or the rating for the action may be higher than if the first user simply views the user-profile page for the second user.

In particular examples, social-networking system 660 may calculate a coefficient based on the type of relationship between particular objects. Referencing the social graph 700, social-networking system 660 may analyze the number and/or type of edges 706 connecting particular user nodes 702 and concept nodes 704 when calculating a coefficient. As an example and not by way of limitation, user nodes 702 that are connected by a spouse-type edge (representing that the two users are married) may be assigned a higher coefficient than user nodes 702 that are connected by a friend-type edge. In other words, depending upon the weights assigned to the actions and relationships for the particular user, the overall affinity may be determined to be higher for content about the user's spouse than for content about the user's friend. In particular examples, the relationships a user has with another object may affect the weights and/or the ratings of the user's actions with respect to calculating the coefficient for that object. As an example and not by way of limitation, if a user is tagged in a first photo, but merely likes a second photo, social-networking system 660 may determine that the user has a higher coefficient with respect to the first photo than the second photo because having a tagged-in-type relationship with content may be assigned a higher weight and/or rating than having a like-type relationship with content. In particular examples, social-networking system 660 may calculate a coefficient for a first user based on the relationship one or more second users have with a particular object. In other words, the connections and coefficients other users have with an object may affect the first user's coefficient for the object. As an example and not by way of limitation, if a first user is connected to or has a high coefficient for one or more second users, and those second users are connected to or have a high coefficient for a particular object, social-networking system 660 may determine that the first user should also have a relatively high coefficient for the particular object. In particular examples, the coefficient may be based on the degree of separation between particular objects. The lower coefficient may represent the decreasing likelihood that the first user will share an interest in content objects of the user that is indirectly connected to the first user in the social graph 700. As an example and not by way of limitation, social-graph entities that are closer in the social graph 700 (i.e., fewer degrees of separation) may have a higher coefficient than entities that are further apart in the social graph 700.

In particular examples, social-networking system 660 may calculate a coefficient based on location information. Objects that are geographically closer to each other may be considered to be more related or of more interest to each other than more distant objects. In particular examples, the coefficient of a user towards a particular object may be based on the proximity of the object's location to a current location associated with the user (or the location of a client system 630 of the user). A first user may be more interested in other users or concepts that are closer to the first user. As an example and not by way of limitation, if a user is one mile from an airport and two miles from a gas station, social-networking system 660 may determine that the user has a higher coefficient for the airport than the gas station based on the proximity of the airport to the user.

In particular examples, social-networking system 660 may perform particular actions with respect to a user based on coefficient information. Coefficients may be used to predict whether a user will perform a particular action based on the user's interest in the action. A coefficient may be used when generating or presenting any type of objects to a user, such as advertisements, search results, news stories, media, messages, notifications, or other suitable objects. The coefficient may also be utilized to rank and order such objects, as appropriate. In this way, social-networking system 660 may provide information that is relevant to user's interests and current circumstances, increasing the likelihood that they will find such information of interest. In particular examples, social-networking system 660 may generate content based on coefficient information. Content objects may be provided or selected based on coefficients specific to a user. As an example and not by way of limitation, the coefficient may be used to generate media for the user, where the user may be presented with media for which the user has a high overall coefficient with respect to the media object. As another example and not by way of limitation, the coefficient may be used to generate advertisements for the user, where the user may be presented with advertisements for which the user has a high overall coefficient with respect to the advertised object. In particular examples, social-networking system 660 may generate search results based on coefficient information. Search results for a particular user may be scored or ranked based on the coefficient associated with the search results with respect to the querying user. As an example and not by way of limitation, search results corresponding to objects with higher coefficients may be ranked higher on a search-results page than results corresponding to objects having lower coefficients.

In particular examples, social-networking system 660 may calculate a coefficient in response to a request for a coefficient from a particular system or process. To predict the likely actions a user may take (or may be the subject of) in a given situation, any process may request a calculated coefficient for a user. The request may also include a set of weights to use for various factors used to calculate the coefficient. This request may come from a process running on the online social network, from a third-party system 670 (e.g., via an API or other communication channel), or from another suitable system. In response to the request, social-networking system 660 may calculate the coefficient (or access the coefficient information if it has previously been calculated and stored). In particular examples, social-networking system 660 may measure an affinity with respect to a particular process. Different processes (both internal and external to the online social network) may request a coefficient for a particular object or set of objects. Social-networking system 660 may provide a measure of affinity that is relevant to the particular process that requested the measure of affinity. In this way, each process receives a measure of affinity that is tailored for the different context in which the process will use the measure of affinity.

In connection with social-graph affinity and affinity coefficients, particular examples may utilize one or more systems, components, elements, functions, methods, operations, or steps disclosed in U.S. patent application Ser. No. 11/503,093, filed 11 Aug. 2006, U.S. patent application Ser. No. 12/977,027, filed 22 Dec. 2010, U.S. patent application Ser. No. 12/978,265, filed 23 Dec. 2010, and U.S. patent application Ser. No. 13/632,869, filed 1 Oct. 2012, each of which is incorporated by reference.

### Privacy

In particular examples, one or more of the content objects of the online social network may be associated with a privacy setting. The privacy settings (or “access settings”) for an object may be stored in any suitable manner, such as, for example, in association with the object, in an index on an authorization server, in another suitable manner, or any combination thereof. A privacy setting of an object may specify how the object (or particular information associated with an object) may be accessed (e.g., viewed or shared) using the online social network. Where the privacy settings for an object allow a particular user to access that object, the object may be described as being “visible” with respect to that user. As an example and not by way of limitation, a user of the online social network may specify privacy settings for a user-profile page that identify a set of users that may access the work experience information on the user-profile page, thus excluding other users from accessing the information. In particular examples, the privacy settings may specify a “blocked list” of users that should not be allowed to access certain information associated with the object. In other words, the blocked list may specify one or more users or entities for which an object is not visible. As an example and not by way of limitation, a user may specify a set of users that may not access photos albums associated with the user, thus excluding those users from accessing the photo albums (while also possibly allowing certain users not within the set of users to access the photo albums). In particular examples, privacy settings may be associated with particular social-graph elements. Privacy settings of a social-graph element, such as a node or an edge, may specify how the social-graph element, information associated with the social-graph element, or content objects associated with the social-graph element may be accessed using the online social network. As an example and not by way of limitation, a particular concept node 704 corresponding to a particular photo may have a privacy setting specifying that the photo may be accessed by users tagged in the photo and their friends. In particular examples, privacy settings may allow users to opt in or opt out of having their actions logged by social-networking system 660 or shared with other systems (e.g., third-party system 670). In particular examples, the privacy settings associated with an object may specify any suitable granularity of permitted access or denial of access. As an example and not by way of limitation, access or denial of access may be specified for particular users (e.g., me, my roommates, and my boss), users within a particular degrees-of-separation (e.g., friends, or friends-of-friends), user groups (e.g., the gaming club, my family), user networks (e.g., employees of particular employers, students or alumni of particular university), all users (“public”), no users (“private”), users of third-party systems 670, particular applications (e.g., third-party applications, external websites), other suitable users or entities, or any combination thereof. Although this disclosure describes using particular privacy settings in a particular manner, this disclosure contemplates using any suitable privacy settings in any suitable manner.

In particular examples, one or more servers 662 may be authorization/privacy servers for enforcing privacy settings. In response to a request from a user (or other entity) for a particular object stored in a data store 664, social-networking system 660 may send a request to the data store 664 for the object. The request may identify the user associated with the request and may be sent to the user (or a client system 630 of the user) if the authorization server determines that the user is authorized to access the object based on the privacy settings associated with the object. If the requesting user is not authorized to access the object, the authorization server may prevent the requested object from being retrieved from the data store 664, or may prevent the requested object from being sent to the user. In the search query context, an object may be generated as a search result if the querying user is authorized to access the object. In other words, the object may have a visibility that is visible to the querying user. If the object has a visibility that is not visible to the user, the object may be excluded from the search results. Although this disclosure describes enforcing privacy settings in a particular manner, this disclosure contemplates enforcing privacy settings in any suitable manner.

### Systems and Methods

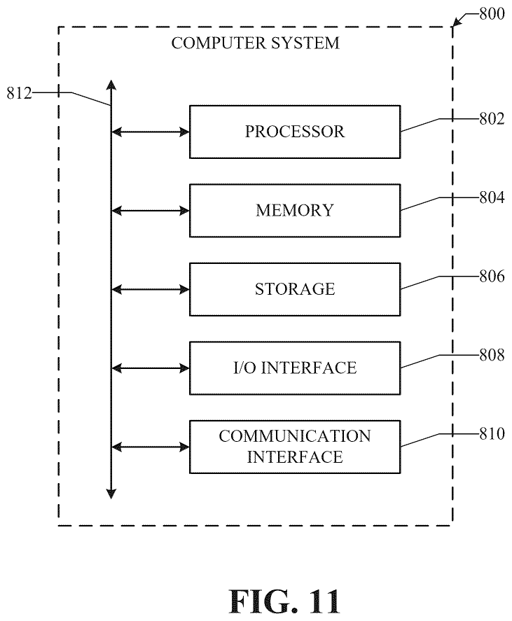

FIG. 11 illustrates an example computer system 800. The system 800 may implement one or more aspects of the process 200 (FIGS. 1 and 2), exemplary ML framework 100 (FIG. 3), process 146 (FIG. 4), ML inference process 150 (FIG. 5), training phase 160 (FIG. 6), an inference process 170 (FIG. 7) and/or method 300 (FIG. 8) already discussed. In particular examples, one or more computer systems 800 perform one or more steps of one or more methods described or illustrated herein. In particular examples, one or more computer systems 800 provide functionality described or illustrated herein. In particular examples, software running on one or more computer systems 800 performs one or more steps of one or more methods described or illustrated herein or provides functionality described or illustrated herein. Particular examples include one or more portions of one or more computer systems 800. Herein, reference to a computer system may encompass a computing device, and vice versa, where appropriate. Moreover, reference to a computer system may encompass one or more computer systems, where appropriate.

This disclosure contemplates any suitable number of computer systems 800. This disclosure contemplates computer system 800 taking any suitable physical form. As example and not by way of limitation, computer system 800 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computer system 800 may include one or more computer systems 800; be unitary or distributed; span multiple locations; span multiple machines; span multiple data centers; or reside in a cloud, which may include one or more cloud components in one or more networks. Where appropriate, one or more computer systems 800 may perform without substantial spatial or temporal limitation one or more steps of one or more methods described or illustrated herein. As an example and not by way of limitation, one or more computer systems 800 may perform in real time or in batch mode one or more steps of one or more methods described or illustrated herein. One or more computer systems 800 may perform at different times or at different locations one or more steps of one or more methods described or illustrated herein, where appropriate.

In particular examples, computer system 800 includes a processor 802, memory 804, storage 806, an input/output (I/O) interface 808, a communication interface 810, and a bus 812. Although this disclosure describes and illustrates a particular computer system having a particular number of particular components in a particular arrangement, this disclosure contemplates any suitable computer system having any suitable number of any suitable components in any suitable arrangement.

In particular examples, processor 802 includes hardware for executing instructions, such as those making up a computer program. As an example and not by way of limitation, to execute instructions, processor 802 may retrieve (or fetch) the instructions from an internal register, an internal cache, memory 804, or storage 806; decode and execute them; and then write one or more results to an internal register, an internal cache, memory 804, or storage 806. In particular examples, processor 802 may include one or more internal caches for data, instructions, or addresses. This disclosure contemplates processor 802 including any suitable number of any suitable internal caches, where appropriate. As an example and not by way of limitation, processor 802 may include one or more instruction caches, one or more data caches, and one or more translation lookaside buffers (TLBs). Instructions in the instruction caches may be copies of instructions in memory 804 or storage 806, and the instruction caches may speed up retrieval of those instructions by processor 802. Data in the data caches may be copies of data in memory 804 or storage 806 for instructions executing at processor 802 to operate on; the results of previous instructions executed at processor 802 for access by subsequent instructions executing at processor 802 or for writing to memory 804 or storage 806; or other suitable data. The data caches may speed up read or write operations by processor 802. The TLBs may speed up virtual-address translation for processor 802. In particular examples, processor 802 may include one or more internal registers for data, instructions, or addresses. This disclosure contemplates processor 802 including any suitable number of any suitable internal registers, where appropriate. Where appropriate, processor 802 may include one or more arithmetic logic units (ALUs); be a multi-core processor; or include one or more processors 802. Although this disclosure describes and illustrates a particular processor, this disclosure contemplates any suitable processor.

In particular examples, memory 804 includes main memory for storing instructions for processor 802 to execute or data for processor 802 to operate on. As an example and not by way of limitation, computer system 800 may load instructions from storage 806 or another source (such as, for example, another computer system 800) to memory 804. Processor 802 may then load the instructions from memory 804 to an internal register or internal cache. To execute the instructions, processor 802 may retrieve the instructions from the internal register or internal cache and decode them. During or after execution of the instructions, processor 802 may write one or more results (which may be intermediate or final results) to the internal register or internal cache. Processor 802 may then write one or more of those results to memory 804. In particular examples, processor 802 executes instructions in one or more internal registers or internal caches or in memory 804 (as opposed to storage 806 or elsewhere) and operates on data in one or more internal registers or internal caches or in memory 804 (as opposed to storage 806 or elsewhere). One or more memory buses (which may each include an address bus and a data bus) may couple processor 802 to memory 804. Bus 812 may include one or more memory buses, as described below. In particular examples, one or more memory management units (MMUs) reside between processor 802 and memory 804 and facilitate accesses to memory 804 requested by processor 802. In particular examples, memory 804 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 804 may include one or more memories 804, where appropriate. Although this disclosure describes and illustrates particular memory, this disclosure contemplates any suitable memory.

In particular examples, storage 806 includes mass storage for data or instructions. As an example and not by way of limitation, storage 806 may include a hard disk drive (HDD), a floppy disk drive, flash memory, an optical disc, a magneto-optical disc, magnetic tape, or a Universal Serial Bus (USB) drive or a combination of two or more of these. Storage 806 may include removable or non-removable (or fixed) media, where appropriate. Storage 806 may be internal or external to computer system 800, where appropriate. In particular examples, storage 806 is non-volatile, solid-state memory. In particular examples, storage 806 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 806 taking any suitable physical form. Storage 806 may include one or more storage control units facilitating communication between processor 802 and storage 806, where appropriate. Where appropriate, storage 806 may include one or more storages 806. Although this disclosure describes and illustrates particular storage, this disclosure contemplates any suitable storage.

In particular examples, I/O interface 808 includes hardware, software, or both, providing one or more interfaces for communication between computer system 800 and one or more I/O devices. Computer system 800 may include one or more of these I/O devices, where appropriate. One or more of these I/O devices may enable communication between a person and computer system 800. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 808 for them. Where appropriate, I/O interface 808 may include one or more device or software drivers enabling processor 802 to drive one or more of these I/O devices. I/O interface 808 may include one or more I/O interfaces 808, where appropriate. Although this disclosure describes and illustrates a particular I/O interface, this disclosure contemplates any suitable I/O interface.

In particular examples, communication interface 810 includes hardware, software, or both providing one or more interfaces for communication (such as, for example, packet-based communication) between computer system 800 and one or more other computer systems 800 or one or more networks. As an example and not by way of limitation, communication interface 810 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 810 for it. As an example and not by way of limitation, computer system 800 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 800 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 800 may include any suitable communication interface 810 for any of these networks, where appropriate. Communication interface 810 may include one or more communication interfaces 810, where appropriate. Although this disclosure describes and illustrates a particular communication interface, this disclosure contemplates any suitable communication interface.

In particular examples, bus 812 includes hardware, software, or both coupling components of computer system 800 to each other. As an example and not by way of limitation, bus 812 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 812 may include one or more buses 812, where appropriate. Although this disclosure describes and illustrates a particular bus, this disclosure contemplates any suitable bus or interconnect.

### EXAMPLES

Example 1 includes at least one computer readable storage medium comprising a set of instructions, which when executed by a computing device, cause the computing device to receive different numbers of accesses to a data shard from different regions, where the data shard is a portion of a dataset, identify, with a machine learning model, access patterns based on the different numbers of accesses, generate, with the machine learning model, values for the different regions based on the access patterns, where the values indicate whether the different regions are to receive the data shard or be bypassed to receive the data shard, determine a subset of the different regions to store the data shard based on the values, and store a replica of the data shard in the subset of the regions.

Example 2 includes the at least one computer readable storage medium of claim 1, where the instructions, when executed, cause the computing device to apply a sliding window to a set of numbers of accesses to identify the different numbers of accesses, where the sliding window extends over a period of time that includes a first portion of the set of the numbers of accesses from a first day, and a second portion of the set of the numbers of accesses from a second day, where the different numbers of accesses include the first portion and the second portion.

Example 3 includes the at least one computer readable storage medium of claim 1, where the instructions, when executed, cause the computing device to, during a training process of the machine learning model identify prediction values of the different regions, where the prediction values are associated with a future number of predicted accesses, order the different regions according to the prediction values into an arrangement that represents the ranks, identify first regions of the different regions that are arranged below a threshold according to the order, and assign the first regions different first values, where the different first values are one of positive numbers or negative numbers.

Example 4 includes the at least one computer readable storage medium of claim 3, where the first values represent the ranks of the first regions.

Example 5 includes the at least one computer readable storage medium of claim 3, where during the training process of the machine learning model, the instructions, when executed, cause the computing device to identify second regions of the different regions that are arranged above the threshold according to the order, and assign the second regions a second value, where the second values are the other of the positive numbers or the negative numbers.

Example 6 includes the at least one computer readable storage medium of claim 5, where all of the second values are the same value.

Example 7 includes the at least one computer readable storage medium of claim 5, where during the training process of the machine learning model, the instructions, when executed, cause the computing device to determine that the first regions are to receive the data shard, and determine that the second regions are to be bypassed for receiving the data shard.

Example 8 includes a system comprising one or more processors, and a memory coupled to the one or more processors, the memory comprising instructions executable by the one or more processors, the one or more processors being operable when executing the instructions to receive different numbers of accesses to a data shard from different regions, where the data shard is a portion of a dataset, identify, with a machine learning model, access patterns based on the different numbers of accesses, generate, with the machine learning model, values for the different regions based on the access patterns, where the values indicate whether the different regions are to receive the data shard or be bypassed to receive the data shard, determine a subset of the different regions to store the data shard based on the values, and store a replica of the data shard in the subset of the regions.

Example 9 includes the system of claim 8, where the one or more processors are further operable when executing the instructions to apply a sliding window to a set of numbers of accesses to identify the different numbers of accesses, where the sliding window extends over a period of time that includes a first portion of the set of the numbers of accesses from a first day, and a second portion of the set of the numbers of accesses from a second day, where the different numbers of accesses include the first portion and the second portion.

Example 10 includes the system of claim 8, where the one or more processors are further operable when executing the instructions to, during a training process of the machine learning model, identify prediction values of the different regions, where the prediction values are associated with a future number of predicted accesses, order the different regions according to the prediction values into an arrangement that represents the ranks, identify first regions of the different regions that are arranged below a threshold according to the order, and assign the first regions different first values, where the different first values are one of positive numbers or negative numbers.

Example 11 includes the system of claim 10, where the first values represent the ranks of the first regions.

Example 12 includes the system of claim 10, where during the training process of the machine learning model, the one or more processors are further operable when executing the instructions to identify second regions of the different regions that are arranged above the threshold according to the order, and assign the second regions a second value, where the second values are the other of the positive numbers or the negative numbers.

Example 13 includes the system of claim 12, where all of the second values are the same value.

Example 14 includes the system of claim 12, where during the training process of the machine learning model, the one or more processors are further operable when executing the instructions to determine that the first regions are to receive the data shard, and determine that the second regions are to be bypassed for receiving the data shard.

Example 15 includes a method comprising receiving different numbers of accesses to a data shard from different regions, where the data shard is a portion of a dataset, identifying, with a machine learning model, access patterns based on the different numbers of accesses, generating, with the machine learning model, values for the different regions based on the access patterns, where the values indicate whether the different regions are to receive the data shard or be bypassed to receive the data shard, determining a subset of the different regions to store the data shard based on the values, and storing a replica of the data shard in the subset of the regions.

Example 16 includes the method of claim 15, further comprising applying a sliding window to a set of numbers of accesses to identify the different numbers of accesses, where the sliding window extends over a period of time that includes a first portion of the set of the numbers of accesses from a first day, and a second portion of the set of the numbers of accesses from a second day, where the different numbers of accesses include the first portion and the second portion.

Example 17 includes the method of claim 15, where the method further comprises, during a training process of the machine learning model, identifying prediction values of the different regions, where the prediction values are associated with a future number of predicted accesses, ordering the different regions according to the prediction values into an arrangement that represents the ranks, identifying first regions of the different regions that are arranged below a threshold according to the order, and assigning the first regions different first values, where the different first values are one of positive numbers or negative numbers.

Example 18 includes the method of claim 17, where the first values represent the ranks of the first regions.

Example 19 includes the method of claim 17, further comprising during a training process of the machine learning model, identifying second regions of the different regions that are arranged above the threshold according to the order, and assigning the second regions a second value, where the second values are the other of the positive numbers or the negative numbers.

Example 20 includes the method of claim 19, further comprising during the training process of the machine learning model determining that the first regions are to receive the data shard, and determining that the second regions are to be bypassed for receiving the data shard.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Examples are applicable for use with all types of semiconductor integrated circuit (“IC”) chips. Examples of these IC chips include but are not limited to processors, controllers, chipset components, programmable logic arrays (PLAs), memory chips, network chips, systems on chip (SOCs), SSD/NAND controller ASICs, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary examples to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although examples are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the examples. Further, arrangements may be shown in block diagram form in order to avoid obscuring examples, and also in view of the fact that specifics with respect to implementation of such block diagram arrangements are highly dependent upon the computing system within which the example is to be implemented, i.e., such specifics should be well within purview of one skilled in the art. Where specific details (e.g., circuits) are set forth in order to describe example examples, it should be apparent to one skilled in the art that examples may be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein to facilitate discussion, and carry no particular temporal or chronological significance unless otherwise indicated.

As used in this application and in the claims, a list of items joined by the term “one or more of” may mean any combination of the listed terms. For example, the phrases “one or more of A, B or C” may mean A; B; C; A and B; A and C; B and C; or A, B and C.

Those skilled in the art will appreciate from the foregoing description that the broad techniques of the examples may be implemented in a variety of forms. Therefore, while the examples have been described in connection with particular examples thereof, the true scope of the examples should not be so limited since other modifications will become apparent to the skilled practitioner upon a study of the drawings, specification, and following claims.

### Examples

Example 1 includes at least one computer readable storage medium comprising a set of instructions, which when executed by a computing device, cause the computing device to receive different numbers of accesses to a data shard from different regions, where the data shard is a portion of a dataset, identify, with a machine learning model, access patterns based on the different numbers of accesses, generate, with the machine learning model, values for the different regions based on the access patterns, where the values indicate whether the different regions are to receive the data shard or be bypassed to receive the data shard, determine a subset of the different regions to store the data shard based on the values, and store a replica of the data shard in the subset of the different regions.

Example 2 includes the at least one computer readable storage medium of Example 1, where the instructions, when executed, cause the computing device to apply a sliding window to a set of numbers of accesses to identify the different numbers of accesses, where the sliding window extends over a period of time that includes a first portion of the set of the numbers of accesses from a first day, and a second portion of the set of the numbers of accesses from a second day, where the different numbers of accesses include the first portion and the second portion.

Example 3 includes the at least one computer readable storage medium of Example 1, where the instructions, when executed, cause the computing device to, during a training process of the machine learning model identify prediction values of the different regions associated with a future number of predicted accesses, order the different regions according to the prediction values into an arrangement that represents ranks, identify first regions of the different regions that are arranged below a threshold according to the order, and assign the first regions different first values, where the different first values are one of positive numbers or negative numbers.

Example 4 includes the at least one computer readable storage medium of Example 3, where the different first values represent the ranks of the first regions.

Example 5 includes the at least one computer readable storage medium of Example 3, where during the training process of the machine learning model, the instructions, when executed, cause the computing device to identify second regions of the different regions that are arranged above the threshold according to the order, and assign second values to the second regions, where the second values are the other of the positive numbers or the negative numbers.

Example 6 includes the at least one computer readable storage medium of Example 5, where all of the second values are the same value.

Example 7 includes the at least one computer readable storage medium of Example 5, where during the training process of the machine learning model, the instructions, when executed, cause the computing device to determine that the first regions are to receive the data shard, and determine that the second regions are to be bypassed for receiving the data shard.

Example 8 includes a system comprising one or more processors, and a memory coupled to the one or more processors, the memory comprising instructions executable by the one or more processors, the one or more processors being operable when executing the instructions to receive different numbers of accesses to a data shard from different regions, where the data shard is a portion of a dataset, identify, with a machine learning model, access patterns based on the different numbers of accesses, generate, with the machine learning model, values for the different regions based on the access patterns, where the values indicate whether the different regions are to receive the data shard or be bypassed to receive the data shard, determine a subset of the different regions to store the data shard based on the values, and store a replica of the data shard in the subset of the different regions.

Example 9 includes the system of Example 8, where the one or more processors are further operable when executing the instructions to apply a sliding window to a set of numbers of accesses to identify the different numbers of accesses, where the sliding window extends over a period of time that includes a first portion of the set of the numbers of accesses from a first day, and a second portion of the set of the numbers of accesses from a second day, where the different numbers of accesses include the first portion and the second portion.

Example 10 includes the system of Example 8, where the one or more processors are further operable when executing the instructions to, during a training process of the machine learning model identify prediction values of the different regions, where the prediction values are associated with a future number of predicted accesses, order the different regions according to the prediction values into an arrangement that represents ranks, identify first regions of the different regions that are arranged below a threshold according to the order, and assign the first regions different first values, where the different first values are one of positive numbers or negative numbers.

Example 11 includes the system of Example 10, where the different first values represent the ranks of the first regions.

Example 12 includes the system of Example 10, where during the training process of the machine learning model, the one or more processors are further operable when executing the instructions to identify second regions of the different regions that are arranged above the threshold according to the order, and assign second values to the second regions, where the second values are the other of the positive numbers or the negative numbers.

Example 13 includes the system of Example 12, where all of the second values are the same value.

Example 14 includes the system of Example 12, where during the training process of the machine learning model, the one or more processors are further operable when executing the instructions to determine that the first regions are to receive the data shard, and determine that the second regions are to be bypassed for receiving the data shard.

Example 15 includes a method comprising receiving different numbers of accesses to a data shard from different regions, where the data shard is a portion of a dataset, identifying, with a machine learning model, access patterns based on the different numbers of accesses, generating, with the machine learning model, values for the different regions based on the access patterns, where the values indicate whether the different regions are to receive the data shard or be bypassed to receive the data shard, determining a subset of the different regions to store the data shard based on the values, and storing a replica of the data shard in the subset of the different regions.

Example 16 includes the method of Example 15, further comprising applying a sliding window to a set of numbers of accesses to identify the different numbers of accesses, where the sliding window extends over a period of time that includes a first portion of the set of the numbers of accesses from a first day, and a second portion of the set of the numbers of accesses from a second day, where the different numbers of accesses include the first portion and the second portion.

Example 17 includes the method of Example 15, where the method further comprises during a training process of the machine learning model identifying prediction values of the different regions, where the prediction values are associated with a future number of predicted accesses, ordering the different regions according to the prediction values into an arrangement that represents the ranks, identifying first regions of the different regions that are arranged below a threshold according to the order, and assigning the first regions different first values, where the different first values are one of positive numbers or negative numbers.

Example 18 includes the method of Example 17, where the different first values represent the ranks of the first regions.

Example 19 includes the method of Example 17, further comprising during the training process of the machine learning model identifying second regions of the different regions that are arranged above the threshold according to the order, and assigning second values to the second regions, where the second values are the other of the positive numbers or the negative numbers.

Example 20 includes the method of Example 19, further comprising during the training process of the machine learning model determining that the first regions are to receive the data shard, and determining that the second regions are to be bypassed for receiving the data shard.

We claim:

1. At least one computer readable storage medium comprising a set of instructions, which when executed by a computing device, cause the computing device to:
receive different numbers of accesses to a data shard from different regions, wherein the data shard is a portion of a dataset;
identify, with a machine learning model, access patterns based on the different numbers of accesses;
generate, with the machine learning model, values for the different regions based on the access patterns, wherein the values indicate whether the different regions are to receive the data shard or be bypassed to receive the data shard;
determine a subset of the different regions to store the data shard based on the values; and
store a replica of the data shard in the subset of the different regions.

2. The at least one computer readable storage medium of claim 1, wherein the instructions, when executed, cause the computing device to:
apply a sliding window to a set of numbers of accesses to identify the different numbers of accesses, wherein the sliding window extends over a period of time that includes a first portion of the set of the numbers of accesses from a first day, and a second portion of the set of the numbers of accesses from a second day, wherein the different numbers of accesses include the first portion and the second portion.

3. The at least one computer readable storage medium of claim 1, wherein the instructions, when executed, cause the computing device to, during a training process of the machine learning model:
identify prediction values of the different regions associated with a future number of predicted accesses;
order the different regions according to the prediction values into an arrangement that represents ranks;
identify first regions of the different regions that are arranged below a threshold according to the order; and
assign the first regions different first values, wherein the different first values are one of positive numbers or negative numbers.

4. The at least one computer readable storage medium of claim 3, wherein the different first values represent the ranks of the first regions.

5. The at least one computer readable storage medium of claim 3, wherein during the training process of the machine learning model, the instructions, when executed, cause the computing device to:
identify second regions of the different regions that are arranged above the threshold according to the order; and
assign second values to the second regions, wherein the second values are the other of the positive numbers or the negative numbers.

6. The at least one computer readable storage medium of claim 5, wherein all of the second values are the same value.

7. The at least one computer readable storage medium of claim 5, wherein during the training process of the machine learning model, the instructions, when executed, cause the computing device to:
determine that the first regions are to receive the data shard; and
determine that the second regions are to be bypassed for receiving the data shard.

8. A system comprising:
one or more processors; and
a memory coupled to the one or more processors, the memory comprising instructions executable by the one or more processors, the one or more processors being operable when executing the instructions to:
receive different numbers of accesses to a data shard from different regions, wherein the data shard is a portion of a dataset,
identify, with a machine learning model, access patterns based on the different numbers of accesses;
generate, with the machine learning model, values for the different regions based on the access patterns, wherein the values indicate whether the different regions are to receive the data shard or be bypassed to receive the data shard,
determine a subset of the different regions to store the data shard based on the values, and
store a replica of the data shard in the subset of the different regions.

9. The system of claim 8, wherein the one or more processors are further operable when executing the instructions to:
apply a sliding window to a set of numbers of accesses to identify the different numbers of accesses, wherein the sliding window extends over a period of time that includes a first portion of the set of the numbers of accesses from a first day, and a second portion of the set of the numbers of accesses from a second day, wherein the different numbers of accesses include the first portion and the second portion.

10. The system of claim 8, wherein the one or more processors are further operable when executing the instructions to, during a training process of the machine learning model:
identify prediction values of the different regions, wherein the prediction values are associated with a future number of predicted accesses;
order the different regions according to the prediction values into an arrangement that represents ranks;
identify first regions of the different regions that are arranged below a threshold according to the order; and
assign the first regions different first values, wherein the different first values are one of positive numbers or negative numbers.

11. The system of claim 10, wherein the different first values represent the ranks of the first regions.

12. The system of claim 10, wherein during the training process of the machine learning model, the one or more processors are further operable when executing the instructions to:
identify second regions of the different regions that are arranged above the threshold according to the order; and
assign second values to the second regions, wherein the second values are the other of the positive numbers or the negative numbers.

13. The system of claim 12, wherein all of the second values are the same value.

14. The system of claim 12, wherein during the training process of the machine learning model, the one or more processors are further operable when executing the instructions to:
determine that the first regions are to receive the data shard; and
determine that the second regions are to be bypassed for receiving the data shard.

15. A method comprising:
receiving different numbers of accesses to a data shard from different regions, wherein the data shard is a portion of a dataset;
identifying, with a machine learning model, access patterns based on the different numbers of accesses;
generating, with the machine learning model, values for the different regions based on the access patterns, wherein the values indicate whether the different regions are to receive the data shard or be bypassed to receive the data shard;
determining a subset of the different regions to store the data shard based on the values; and
storing a replica of the data shard in the subset of the different regions.

16. The method of claim 15, further comprising:
applying a sliding window to a set of numbers of accesses to identify the different numbers of accesses, wherein the sliding window extends over a period of time that includes a first portion of the set of the numbers of accesses from a first day, and a second portion of the set of the numbers of accesses from a second day, wherein the different numbers of accesses include the first portion and the second portion.

17. The method of claim 15, wherein the method further comprises during a training process of the machine learning model:
identifying prediction values of the different regions, wherein the prediction values are associated with a future number of predicted accesses;
ordering the different regions according to the prediction values into an arrangement that represents the ranks;
identifying first regions of the different regions that are arranged below a threshold according to the order; and
assigning the first regions different first values, wherein the different first values are one of positive numbers or negative numbers.

18. The method of claim 17, wherein the different first values represent the ranks of the first regions.

19. The method of claim 17, further comprising during the training process of the machine learning model:
identifying second regions of the different regions that are arranged above the threshold according to the order; and
assigning second values to the second regions, wherein the second values are the other of the positive numbers or the negative numbers.

20. The method of claim 19, further comprising during the training process of the machine learning model:
determining that the first regions are to receive the data shard; and
determining that the second regions are to be bypassed for receiving the data shard.
